(19) United States
(12) Patent Application Publication
(10) Pub. No.: US 2021/0406736 A1
(43) Pub. Date: Dec. 30, 2021

(54) SYSTEM AND METHOD OF CONTENT RECOMMENDATION

(71) Applicant: REKAMMEND INC., Vaughan (CA)

(72) Inventors: Hannah SENNIK, Vaughan (CA); Abiramy KUGANESAN, Brampton (CA)

(21) Appl. No.: 17/359,170

(22) Filed: Jun. 25, 2021

Related U.S. Application Data
(60) Provisional application No. 63/044,469, filed on Jun. 26, 2020.

(51) Int. Cl. G06N 5/04; G06N 20/00

(52) U.S. Cl. CPC G06N 5/04; G06N 20/00

(57) ABSTRACT

A system and method for generating recommended content are provided. The system comprises a processor and a memory, in communication with the processor, that when executed by the processor performs the method. The method comprises receiving at least two context tags associated with a user, identifying from a content repository related content that are related to each context tag through semantics or frequency of use, generating a similarity vector for each context tag that correlates the context tag with the related content for that context tag, inputting the similarity vectors to an inference network, determining a probability distribution for each of the related content based on the output of the inference network, and identifying the recommended content from the related content, based at least in part on a threshold and the probability distributions of the related content. The initial recommended content may be determined through a calibration procedure. The recommended content may be recommended in the form of an experience and may be updated over time.

### CROSS REFERENCE TO RELATED APPLICATIONS

This application is a non-provisional of, and claims all benefit, including priority, to U.S. Application No. 63/044,469, dated Jun. 26, 2020 entitled WORD RECOMMENDER and incorporated herein in its entirety by reference.

### FIELD

This disclosure relates to digital communication and language learning communication, in particular, to recommending content for a user to facilitate communication.

### BACKGROUND

Approximately six million Americans and Canadians face challenges communicating due to temporary or permanent speech impairments. There are several additional individuals who may face challenges communicating due to a language barrier in a new country. In such situations, users may rely on mobile technology to support or replace speech. Such technology provides users with access to a repository of content, which may include words in one or many languages and accompanying images, which can be programmed and organized according to the user's preference and outputted from the mobile device as audio upon selection. However, users are limited by the number of words that can be shown on the screen at one time. This results in nested word menus, which increase the time and cognitive load required by the user to find the words they need to communicate in real time. The impact on users is a speech output rate of 10 words per minute, in comparison to the average communication speed of 155 words per minute for natural speech. Additionally, the vocabulary present on these devices is typically insufficient to fully meet the unique needs of users.

### SUMMARY

According to an aspect, there is provided a computer-implemented method for generating recommended content. The method comprises receiving at least two context tags associated with a user; identifying, from a content repository, related content that are related to each context tag through semantics or frequency of use; generating a similarity vector for each context tag that correlates the context tag with the related content for that context tag; inputting the similarity vectors to an inference network; determining a probability distribution for each of the related content based on the output of the inference network; and identifying the recommended content from the related content, based at least in part on a threshold and the probability distributions of the related content.

In some embodiments, the context tags define an experience associated with the user, and wherein each of the at least two context tags comprise attributes of context of the related content acquired in past communications involving the user.

In some embodiments, the content comprises at least one of: words, phrases, icons or images.

In some embodiments, the content comprises words or phrases in a first language together with words or phrases in a second language.

In some embodiments, the content repository comprises at least one of: a word dictionary, or a phrase dictionary.

In some embodiments, each context tag is associated with a weight based at least in part on a frequency of usage.

In some embodiments, the weight associated with each context tag is updated periodically based on aggregated content usage frequencies over time.

In some embodiments, the context tags are based at least in part on one or more of: a location of the user, an identity of a communication partner, a status of an environment, a time, a mood of the user, or a mood of the communication partner.

In some embodiments, the location of the user is determined based at least in part on location data.

In some embodiments, the identity of the communication partner is based at least in part on one or more of speaker recognition or a connection with a device associated with the communication partner.

In some embodiments, the status of the environment is based at least in part on weather data.

In some embodiments, the time is based at least in part on at least one of: a calendar event, a current event, or a duration of a calendar event or a current event.

In some embodiments, the mood of the user is based at least in part on one or more of emotion analysis of text or emotion analysis of speech.

In some embodiments, the mood of the communication partner is based at least in part on one or more of emotion analysis of text or emotion analysis of speech.

In some embodiments, the method further comprises receiving an input selection of at least one word or icon, and providing one or more full phrase recommendations based on the input selection and related context tags.

In some embodiments, the method further comprises receiving additional context tags associated with other users based on shared experiences, identifying from the content repository content that are that are related to each context tag through semantics or frequency of use, and populating a base model of shared experiences between the user and other users.

In some embodiments, the method further comprises pre-populating content using images of at least one of content or content boards.

In some embodiments, populating the base model comprises obtaining crowd source data from experiences shared among a group of users.

In some embodiments, populating the base model comprises obtaining data from shared experiences among a group of users.

In some embodiments, populating the base model comprises obtaining experience data associated with the user, and training the base model using said experience data associated with the user.

In some embodiments, populating the base model comprises obtaining anonymized experience data from at least two users, identifying similarities among anonymized experience data, and selecting a pre-defined base model that matches the similarities among the anonymized experience data.

In some embodiments, populating the base model comprises determining a category associated with the user, and selecting a pre-defined base model for that category.

In some embodiments, the similarity vector is generated using a content embedding model.

In some embodiments, the method further comprises presenting/displaying the recommended content.

In some embodiments, the method further comprises receiving new content, and adding the new content to the content repository.

In some embodiments, the new content is determined based on at least one of: text entry, speaker recognition, optical character recognition, or object recognition.

In some embodiments, the method further comprises determining an audio associated with the recommended content, based at least in part on the context tags.

In some embodiments, the recommended content is based at least in part on historical content use frequency.

In some embodiments, the threshold is based at least in part on a pre-defined number of recommended contents.

According to another aspect, there is provided a computer-implemented method for generating recommended content, the method comprising: receiving at least one context tag associated with a user environment; generating a similarity vector for each context tag that correlates the context tag with related experiences from an experience dictionary; inputting the similarity vectors to an inference network; determining a probability distribution for each of the related experiences based on the output of the inference network; identifying the recommended experiences from the related experiences, based at least in part on a threshold and the probability distributions of the related experiences; generating a similarity vector for each context tag that correlates the context tag with related content from the recommended experiences; inputting the cosine similarity vectors to an inference network; determining a probability distribution for each of the related content based on the output of the inference network; and identifying the recommended content from the related content, based at least in part on a threshold and the probability distributions of the related content.

In some embodiments, the environment comprises one or more of: a location of the user, an identity of a communication partner, a status of an environment, a time, a mood of the user, or a mood of the communication partner.

In some embodiments, the experience dictionary is associated with the user.

In some embodiments, the experience dictionary is a community experience dictionary.

In some embodiments, each experience is associated with a weight based at least in part on a frequency of experience occurrence associated with the user.

In some embodiments, the weight associated with each experience is updated periodically based on aggregated experience occurrence frequencies over time.

According to another aspect, there is provided a computer system comprising: a processor; a memory in communication with the processor, the memory storing instructions that, when executed by the processor cause the processor to perform a method as disclosed herein.

According to another aspect, there is provided a non-transitory computer readable medium comprising a computer readable memory storing computer executable instructions thereon that when executed by a computer causes the computer to perform a method as described herein.

Other features will become apparent from the drawings in conjunction with the following description.

### BRIEF DESCRIPTION OF DRAWINGS

In the figures which illustrate example embodiments,

FIGS. 1A to 1C illustrates screenshots of an SGD interface with icon-based keyboard (orthography only), according to an embodiment;

FIG. 2 illustrates an example of a recommended content system environment, in accordance with some embodiments;

FIG. 3 illustrates an example of inputs to a context identification component of a contextual content recommender system, in accordance with some embodiments;

FIGS. 4A and 4B illustrate examples of system interaction diagrams of a contextual content recommender system for generating word recommendations, in accordance with some embodiments;

FIG. 5 is a schematic block diagram of a communication system for generating content recommendations, in accordance with some embodiments;

FIG. 6 is a schematic block diagram illustrating examples of context tags as context identification, in accordance with some embodiments;

FIG. 7 illustrates the example of the recommended content system environment in more detail, in accordance with some embodiments;

FIG. 8 illustrates an example of location detection, in accordance with some embodiments;

FIG. 9 is a schematic block diagram of inputs used to determine a location of a user, in accordance with some embodiments;

FIG. 10 is a schematic block diagram illustrating an example of a process to determine a location of a user, in accordance with some embodiments;

FIG. 11 is a schematic block diagram of data sources to determine an identity of a communication partner, in accordance with some embodiments;

FIG. 12 is a schematic block diagram illustrating an example of a process to add a new communication partner, in accordance with some embodiments;

FIGS. 13A to 13E illustrates screenshots of a workflow for adding a new communication partner, in accordance with some embodiments;

FIG. 14 is a schematic block diagram illustrating an example of a process to identify a communication partner, in accordance with some embodiments;

FIG. 15 is a schematic block diagram illustrating an example of a process to determine a status of environment, in accordance with some embodiments;

FIG. 16 is a schematic block diagram illustrating an example of a process to determine time-based context tags, in accordance with some embodiments;

FIG. 17 is a schematic block diagram of examples of sources to obtain a mood of a user, in accordance with some embodiments;

FIG. 18 is a schematic block diagram of examples of sources to obtain a mood of a communication partner, in accordance with some embodiments;

FIG. 19A illustrates a screenshot depicting an example of a context tag and associated recommendation content, in accordance with some embodiments;

FIG. 19B illustrates a screenshot of an example of a content board for a context tag, in accordance with some embodiments;

FIG. 20A is a screenshot of an example of a system interface with an update context button, in accordance with some embodiments;

FIG. 20B is a screenshot of an example of a pop-up prompt to update to a detected context, in accordance with some embodiments;

FIG. 21 is a screenshot of an example of a system interface with an option to manually select a context, in accordance with some embodiments;

FIG. 22 is an example tag normalized similarity vector, in accordance with some embodiments;

FIG. 23 illustrates an example network architecture of an inference network, in accordance with some embodiments;

FIG. 24A is a table of sample recommended content and associated probabilities generated by a recommender, in accordance with some embodiments;

FIG. 24B is an example of input context tags and corresponding recommended content and associated probabilities, in accordance with some embodiments;

FIG. 24C is another example of input context tags and corresponding recommended experiences and associated probabilities, in accordance with some embodiments;

FIG. 25A illustrates an example of associating tags to experiences, in accordance with some embodiments;

FIG. 25B illustrates an example of tag and experience dictionaries, in accordance with some embodiments;

FIG. 26 illustrates an example of a content data structure 2600, in accordance with some embodiments;

FIG. 27 illustrates an example of a content recommender inference process, in accordance with some embodiments;

FIG. 28 illustrates examples of experience, tags and content with an imbalanced match presented to the user, in accordance with some embodiments;

FIG. 29 illustrates, in a flowchart, an example of a process of adding content, experiences, and tags, in accordance with some embodiments;

FIGS. 30A to 30C illustrate an example of Internet connectivity requirements for a model update/fine-tuning process based on historical use, in accordance with some embodiments;

FIG. 31 illustrates an example of a process of adding content to a dictionary, in accordance with some embodiments;

FIG. 32 is a schematic block diagram illustrating an example of a process for content recommendations from manually programmed content, in accordance with some embodiments;

FIG. 33 is a schematic block diagram illustrating an example of a process for content recommendations from voice input and speech recognition, in accordance with some embodiments;

FIG. 34 is a schematic block diagram illustrating an example of a process for content recommendations from object recognition, in accordance with some embodiments;

FIG. 35 illustrates examples of semi-automatic content addition through object recognition, in accordance with some embodiments;

FIG. 36 illustrates an example of a process for automatic organization of new content, in accordance with some embodiments;

FIG. 37 illustrates, in a flow chart, an example of a method for generating recommended content, in accordance with some embodiments;

FIG. 38 illustrates, in a flow chart, an example of a method for generating recommended content based on experience, in accordance with some embodiments; and

FIG. 39 is a block diagram of example hardware and software components of a computing device for content recommendation, in accordance with some embodiments.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DETAILED DESCRIPTION

Speech and language play an important role in everyday life. They allow us to communicate, connect with others, acquire information and learn new things. Unfortunately, several individuals experience challenges expressing themselves verbally due to acquired and developmental neurological conditions, and/or language barriers in new countries. Although speech facilitation and replacement tools exist, they are inadequate when it comes to promoting social inclusion and independence for these individuals. First, the achievable rate of communication is extremely slow due to the amount of searching required to find the desired words required to communicate. This leads to individuals being spoken for or ignored during conversations. Second, the amount of manual programming required to personalize vocabulary in these systems is extremely burdensome. This may lead to individuals being dependent on their care circles to anticipate their communication needs and program vocabulary accordingly.

One of the most common types of systems that may be used is a speech generating device (SGD), which produces a digitized or synthesized speech output based on the user's actions, allowing individuals with communication limitations to translate their thoughts into spoken words. SGDs have been found to have significant impact on users beyond their ability to communicate, with approximately 90% of adult users reporting improvement in general well-being and independence.

Systems and methods disclosed herein can be used by individuals with acquired neurological conditions leading to speech and/or language disorders, including but not limited to, ALS, MS, and aphasia following stroke.

Systems and methods disclosed herein can also be used by individuals with developmental neurological conditions leading to speech and/or language disorders, including but not limited to Autism, Down Syndrome and CP.

Systems and methods disclosed herein can also be used by individuals learning a second language. They may be familiar with a first language and require assistance with translating words and phrases of the first language into the second language and consequently speaking them.

Individuals' usage of SGDs may be supported by a speech language pathologist (SLP), occupational therapist (OT), or a communication partner, which may be a caretaker or a parent. These individuals can be responsible for customizing the SGD through adding additional vocabulary and rearranging the layout to support the individual's needs.

SGDs typically consist of a hardware platform, a communication software which runs on the hardware platform and may include an alternative input device, which allow users to access the software regardless of their physical ability. The hardware platform typically consists of a computing device, for example smartphones or hardware tablets. Communication software exists in a variety of forms, including symbol-based word boards and on-screen keyboards.

Symbol-based word boards or icon-based keyboards can be beneficial for individuals with severe physical disabilities that require them to have large targets on the screen, or individuals who are pre-literate and developing their language; words complemented by relevant images or icons are helpful to this population.

On-screen keyboards allow users to formulate their own messages letter by letter. They are often supported by word prediction, which aims to accelerate the rate of communication.

A middle ground between symbol-based word boards and on-screen keyboards is communication software consisting of word boards without accompanying images. This allows literate users access to whole words that can be pieced together to create sentences; it presents a potential reduction in the number of keystrokes required to formulate a message when compared to an on-screen keyboard.

Alternative input devices include switches, joysticks, eye gaze cameras, etc. These options are useful for individuals with physical impairments that prevent them from having the fine motor control required to make precise selections using their hands on the touch interface.

Based on the computer technology available, an SGD user can have access to a “limitless” word selection, which can be programmed, categorized and organized according to the user's preference. However, there are several flaws with current commercially available technologies. Individuals with communication impairments often experience a loss of independence and reduced quality of life. Although communication software aims to mitigate these challenges, several sources state that the potential of communication software might be limited by the complexity of operation, especially for those who are simultaneously physically impaired and speech-disabled.

SGD users are limited by the number of words that can be shown on the interface at one time. Moreover, the organization of topics may be random. From a survey conducted, the majority of SGD users had between twenty and sixty buttons on each page. This results in nested menus, which increase the time and cognitive load required by the user to communicate. The impact on SGD users is a maximum speech output rate of 10 words per minute (WPM), which is poor compared to the average communication speed of 155 WPM for natural speech. The rates of conversation using communication software that include word prediction fall in the range of 12-18 WPM, indicating a large discrepancy between the rate of communication permitted by communication software and that of natural speech. This leads to many individuals with communication impairments feeling like they “missed opportunities to express opinions and feelings” due to the slow pace of communication using their device.

Additionally, the vocabulary present on traditional SGD devices is typically insufficient to fully meet users' communication needs, with over 90% of SGD users manually programming words to expand their vocabulary. As individuals who use SGD transition from childhood into independent adult life, the standard word sets are not sufficient for them to communicate. A study of three widely used word sets found that a maximum of 26% of common work-related words were found, and similar results were obtained for communication about sexuality.

SGDs are a primary form of communication; however, this technology provides severe limitations for individuals. The slow speed of communication leads to many individuals being undervalued and unable to express their opinions. Literature research reveals that reduced communication rates associated with communication software likely negatively impact communication interactions, including in educational and employment contexts with communication partners accustomed to exchanging information at a rapid pace. Furthermore, the user's reliance on other individuals to add vocabulary into their device, as well as the barrier of not having vocabulary necessary for a situation, provides limitations on the level of independence for SGD users. Improvement of existing SGD technology is desired to improve the speed of communication and breadth of vocabulary, providing users with a feeling of social inclusion, an increase in independence and overall improvement in quality of life.

Outlined below is a plausible scenario that may occur between an SGD user and their co-worker, in a professional setting.

Paul is the Chief Operating Officer (COO) at a startup. At 10 AM one morning, the marketing team is discussing the roll out of a new feature. Paul has misplaced the meeting invite and asks Susan which team members will be attending.

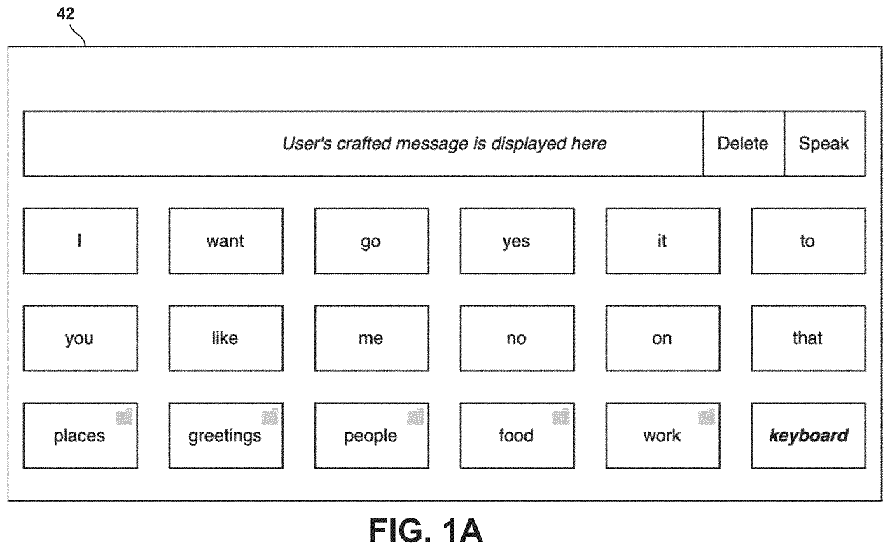

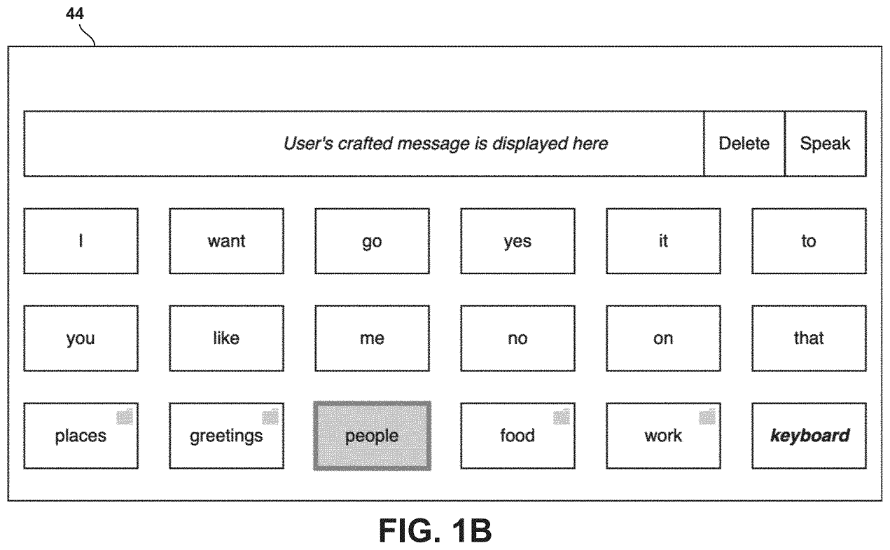

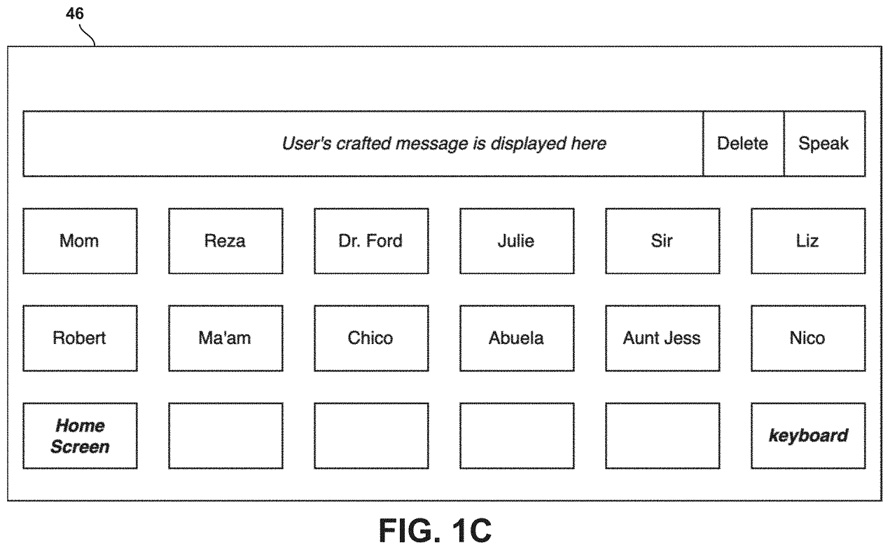

Susan is a prominent member of the marketing team. Last year, she was diagnosed with MS. Due to the progression of her disability, she has lost the ability to produce verbal speech and move the muscles required to interact with a keyboard or touch screen. For these reasons, she uses a joystick to interact with a speech generation device, or SGD, that facilitates verbal interactions with those around her. A screenshot 42 of an example of Susan's SGD interface is shown in FIG. 1A.

Susan must navigate to the “people” folder on the home screen of her device in order to access the names of the meeting attendees and communicate them to Paul, shown by way of example in screenshot 44 illustrated in FIG. 1B.

Upon making a selection for “people”, Susan has access to pre-programmed names of all of the relevant people in her life, as shown in screenshot 36 illustrated in FIG. 1C. Susan's people folder consists of options that have been manually programmed in.

Upon selecting “Julie”, who is one of the meeting attendees, Susan must navigate back to the home screen in order to select the article “and”. After this selection is made, Susan must navigate back to the “people” folder to select the name of the other meeting attendee, “Robert”.

By the time all of this can occur, Paul grows impatient, dismisses Susan, and proceeds to obtain the answer himself. This results in Susan harboring feelings of social isolation, and a general lack of confidence in conversational settings.

Two limitations of existing SGDs are the slow rate of communication (due to high word retrieval times) and the high burden of vocabulary personalization. Individuals with communication impairments who require an SGD to communicate, need to increase the rate of communication (e.g., increase ease of finding/retrieving words) and minimize the amount of manual programming required to personalize vocabulary, in order to achieve social inclusion, increase independence and improve overall quality of life.

The limitations present pain points for not only the primary SGD users, but communication partners as well, who are involved in conversation with the SGD user and may support the programming and organizing of new vocabulary in the SGD.

Embodiments of systems and methods disclosed herein may help users formulate messages independently, increase their rate of communication, increase keystroke savings, and expand system vocabulary independent of caregiver support.

Typically, target users may comprise i) individuals who have little or no functional speech due to a speech and/or language impairment; ii) temporary communication software users (require communication software intervention only for a limited duration of time, e.g., following surgical intervention); and iii) individuals who have a speech and/or language impairment and one or more physical impairments which require the use of alternative input methods, such as switches or eye-gaze systems, to access communication software.

In some embodiments, a target user may wish to learn a language.

Other user populations and their associated needs may also be addressed by systems and methods disclosed herein.

Conveniently, systems and methods disclosed herein may 1) improve the rate of communication for the user through dynamic and contextual content recommendations based on information unique to them and their environment, and 2) allow for semi-automatic addition of content (such as words, phrases, icons, images, etc.) to the SGD based on situation context and historical content use data.

In order to increase the permissible rate of communication, systems and methods disclosed herein can leverage a combination of contextual inputs to determine the overall conversation context and consequently recommend relevant content, based on both the context and the user's preferences. In particular, historical use data, user preferences, real-time information (such as news and weather), sensor or input data (such as GPS, Bluetooth, camera, microphone), and training data that is acquired directly from the user as a form of calibration for a personalized data model can be leveraged to provide informed context-based content recommendations to a user.

In some embodiments described herein, the user and their care circle may provide some base data that can be used to populate the device. The base data may be collected in a manner that makes it very easy for the user and care circle (e.g., speech data from end user if they have progressive disorder and speech still intact, or speech data from relevant communication partners). Such base data may be organized into vocabulary structures by “experiences”.

In some embodiments, systems and methods disclosed herein utilize real time or near real time contextual inputs to create an overall context that correlates to relevant content. Context refers to the detected situation that the user is in. The detected context may comprise a tag or combination of tags. The user may also manually select their context. In some embodiments, a system detects the context of the user in real time, summarizes the context using a series of context tags, uses the context tags to retrieve content relating to the detected context and displays the content to the user.

In some embodiments, systems and methods disclosed herein utilize real time or near real time contextual inputs to create an overall context that correlates to relevant experiences that contain content. Context refers to the detected situation that the user is in. The detected context may comprise a context tag or combination of context tags. The user may also manually select their context. In some embodiments, a system detects the context of the user in real time, summarizes the context using a series of context tags, uses the context tags to match the context to an experience in the system repository, uses the identified experience and underlying tags to retrieve content relating to the experience and any additional experiences with shared tags.

In some embodiments, an experience is a descriptor of the context that stores relevant content on the local and remote database (i.e., content repositories). In some embodiments, content may be stored in a content dictionary such as a word dictionary or a phrase dictionary. A content dictionary may be initialized using crowdsourced data to determine typical correlations between words, phrases, context tags, and experiences. Experiences can comprise instrumental activities of daily living, current events, recounts of previous important events, etc. Common experiences may come pre-programmed on the application, while the user has the ability to create additional, personalized experiences. For example, “Appointment with Family Doctor”. An experience is identified by context tags which are attributes of the context that can be inferred by device sensors or defined by the user. In the “Appointment with Family Doctor” example, sample context tags may be: “family doctor” (communication partner—identified through speaker recognition or a communication connection, such as Bluetooth, with the communication partner's mobile device, wearable, or any other device with communications capability), “appointment” (activity—identified through calendar event), “10 am” (time—identified through system clock), “St. George clinic” (location—identified through GPS and mapping API). The context tags associated with each user are likely to differ based on their frequent contexts and personal experiences. These tags are used to pull up relevant experiences and associated content when a context with overlapping tags is detected.

Content may be words, phrases, icons, images, etc. associated with an experience. Content such as words and phrases may be used to communicate. Icons may accompany words and phrases to assist the user in identification and selection. Images may accompany words and phrases to provide additional context about the meaning of the content and may be shown or shared with others. For example, the word “doctor” may be accompanied by an icon of the caduceus. “I am taking my medication”, “genetic”, “I refilled the prescription”, may be accompanied by images that the user took of their various medication bottles and labels. Content may be selected by the user in order to communicate about a particular experience. Conveniently, context awareness may also allow the device to automatically expand a user's existing content base by adding, organizing and prioritizing new content in a manner that aligns with the user's preferences.

Systems for providing users with recommended words will be described. In some embodiments, the system recommends content based on a context of a situation in which the user finds themselves (content embodiment). In other embodiments, the system recommends one or more experiences (a description of a context that contains a group of content) based on a context of a situation in which the user finds themselves (experience embodiment). The present disclosure will describe similar features of both embodiments together, and also provide teachings of some variations between each embodiment throughout.

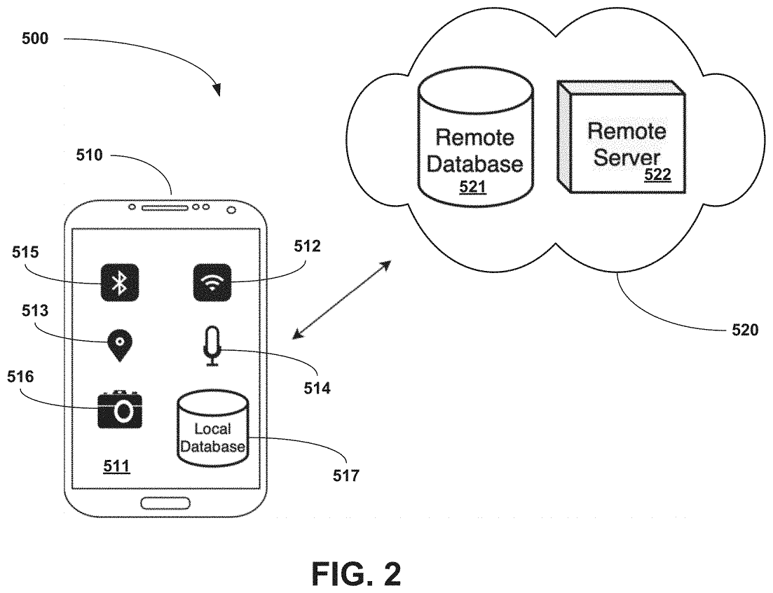

FIG. 2 illustrates an example of a recommended content system environment 500, in accordance with some embodiments. The environment 500 includes a mobile device 510 having a user interface 511, internet connectivity 512, GPS 513, microphone 514, Bluetooth connectivity 515, camera capability 516, and local storage 517 that communicates with a remote database 521 via a remote server 522 both hosted on the cloud 520. Other functionality may be added to the device 510. The components will be described in further detail below.

The system detects the context of the user in real time, summarizes the context using a series of tags, uses the tags to match the context to content or to an experience in the system repository, using the identified experience and underlying tags to retrieve content relating to the experience and any additional content relating to experiences with shared tags.

The system comprises an application which is run on a portable, interface enabled hardware capable of internet connectivity, GPS, microphone input, a local database, Bluetooth connectivity, camera capability, etc. Data is also stored on a remote database which is hosted in the cloud. The hardware platform must be capable of producing audio and visual output.

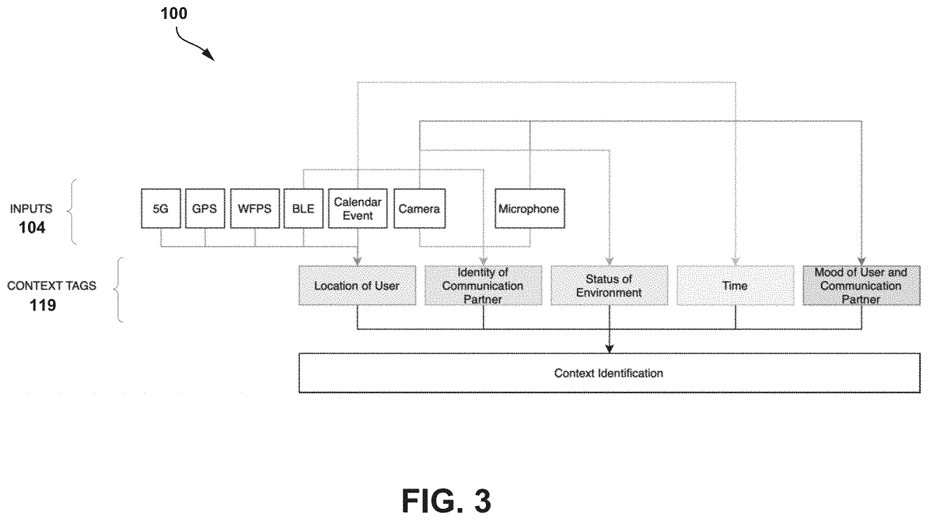

FIG. 3 illustrates an example of inputs 104 to a context identification component of a contextual content recommender system 100 that can run on a hardware platform, such as a mobile device, containing various hardware sensors and storage capabilities, in accordance with some embodiments. System 100 has the ability to interface with various input devices, ensuring that users have the ability to make word selections regardless of their physical abilities.

The backend of system 100 can leverage data from existing sensors or inputs (such as GPS, BLE, etc.) on high tech SGD platforms and software information from real-time device usage to provide contextual content recommendations to the user that improve over time based on historical usage. In some embodiments, words such as “I”, “you”, “go”, “come” may be eliminated from the recommendations as they are typically labeled as “core words” which are either located on the very first page of the communication software running on the SGD or accessed through word prediction. In some embodiments, the system 100 may provide dynamic recommendations in certain contexts.

Inputs collected via hardware and software methods are synthesized and weighted according to situational relevance; this is accomplished using language modeling and reinforcement learning. This approach may ultimately improve the timing and quality of communication by presenting relevant content recommendations to the user. This approach will also allow for the system to learn how the user plans to grow their vocabulary. By referencing frequent situational contexts and historical word use data, the system can suggest novel, individualized content to the user. This indicates that content that has not been pre-programmed in the system can be automatically added to the database (e.g., content repository) and suggested to the user. This is accomplished by learning from the user's habits and interests. In some embodiments, content may be stored in a content dictionary such as a word dictionary or a phrase dictionary. The content dictionary is a list of references to the content such as words and phrases and is used to map the human readable form of the content to the embedded vector form of the content. It typically takes the form of an ordered list with each index corresponding to a content entry. In some embodiments, an ordered list may comprise a table where one column may correspond to an index number and another column may correspond to a content identifier, where the content identifier may be the content or a link to the content.

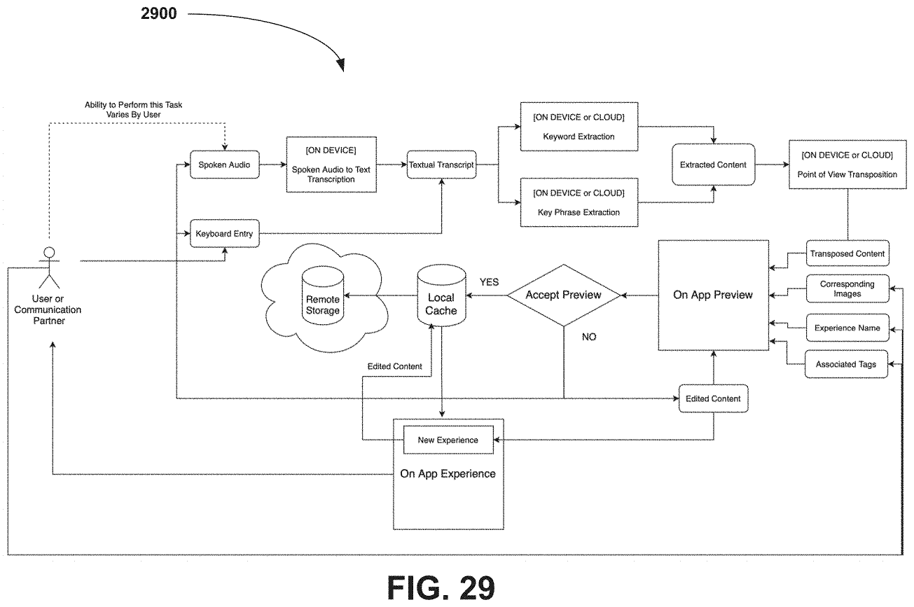

FIG. 29 illustrates, in a flowchart, an example of a process 2900 of adding content, experiences, and tags using the “Tell Us About Yourself” process, in accordance with some embodiments. A user may complete an optional “Tell Us About Yourself” procedure when they first start using the system. This will assist the system in learning about the user's personal interests. This may include but is not limited to, who they usually interact with on a daily basis, what their typical daily schedule is, the locations they frequent, etc. The “Tell Us About Yourself” procedure may focus on questions related to personal experiences, may be accomplished through text-based or voice-based input into the system, and may be accomplished by the user or a member of their care circle.

The system will start initializing content (e.g., word boards, phrase boards, content boards, etc.) for context tags (places, people, etc.) and experiences which are relevant to the user. A board is a grouping of similar items (e.g., content, words, phrases, etc.).

In some embodiments, the information acquired during the “Tell Us About Yourself” procedure may be used to train the user's model prior to first time use of the system using one or many of the following pre-population tasks.

The “Tell Us About Yourself” procedure may be used to inform a user specific training protocol for their base model which only leverages data acquired during this procedure.

The “Tell Us About Yourself” procedure may be used to identify similarities between user segments, which may then be used to select an anonymized pretrained model based on crowd-sourced data between similar user segments. For example, shared interests, experiences, and occupation may inform the training data required for pretraining a common base model. The common base model may comprise shared experiences between users, similar types of users (e.g., similar by one or more of age, occupation, medical status or condition, address, and other demographics). In some embodiments the shared model may be generated (e.g., pre-populated based on pre-determined experiences shared by a community of user types) prior to first usage of the system 100 by a user. In some embodiments, there may be different categories of shared models (e.g., a personal or casual shared model for expected etiquette, words and phrases to be used in casual or friendly conversations, a business or formal shared model for expected etiquette, words and phrases to be used in formal or business conversations). In some embodiments, a user may have a base model that encompasses data used to train multiple base models, or working models, for different scenarios (e.g., casual, formal, different languages, specific complex contexts, etc.).

As illustrated in FIG. 3, system 100 can obtain sensor data from sensors or inputs 104 such as GPS, WFPS, BLE, Calendar Event, Camera, Microphone and Internet.

A hardware platform 103 such as a computing device or components thereof, can provide inputs to system 100, and which may include input/output such as a display, audio, touch screen, such that a user and/or communication partner can interact with, which can include access devices such as switch, joystick and eye gave camera.

Various device data and sensor data, such as that shown in FIG. 3, can be used to generate context tags 119, such as location of user, identity of communication partner, status of environment, time, mood of user and/or communication partner.

Context tags 119 can be used to perform context identification.

In some embodiments, a “context” is the detected situation that the user is in. The detected context comprises a tag or combination of tags. The user may also manually select their context.

In some embodiments, the time tag may include a micro analysis of time. A delta of time may be measured to show content that may be relevant to that stage of the interaction with the other party.

For example, time-based input, coupled with other input modes may be used to analyze user behaviour. For instance, there may be content that is more relevant at different time points during an interaction or context. For example, a user may typically order coffee in the first five minutes that they are in a coffee shop and later switch to a different conversation with a colleague at the coffee shop.

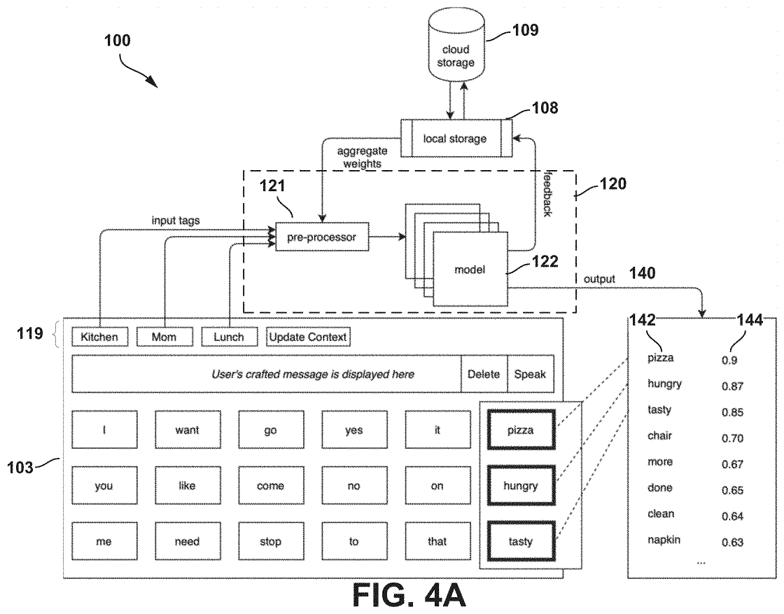

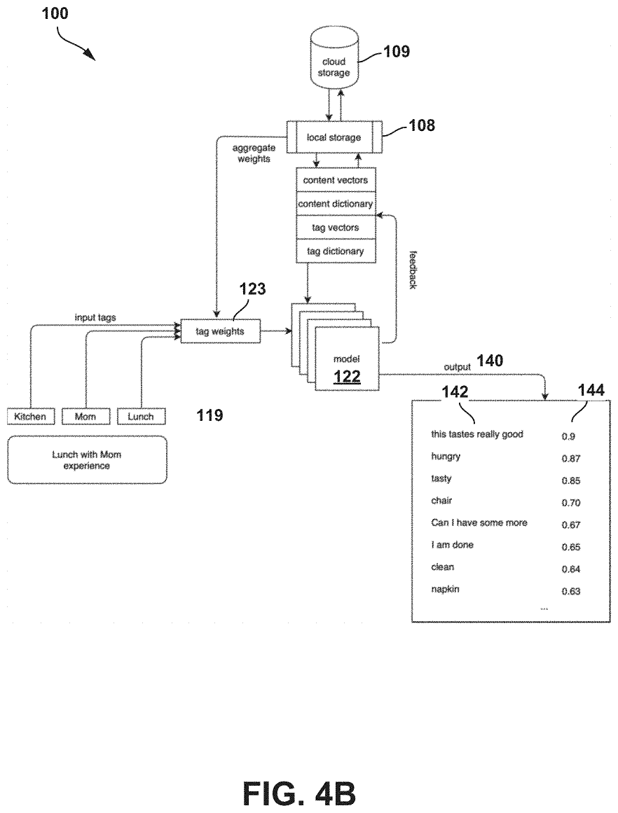

FIGS. 4A and 4B illustrate examples of system interaction diagrams of system 100, in accordance with some embodiments.

System 100 can include local storage 108 and/or remote storage such as cloud storage 109, communicated via a suitable network, not shown.

Context tags 119 are generated by a context analyzer 110. Context tags 119 are input to a content recommender, such as recommender 120, which includes a pre-processor 121 and a model such as inference network 122, which may be embodied as a machine learning framework.

Inference network 122 can generate an output 140, including recommended content or recommended experiences and associated content 142 and associated probabilities 144.

Inference network 122 can further return “feedback”, including updated context tag weights and new content or new experiences with associated content determined by tag weight updater 123, content dictionary updater and experience dictionary updater, respectively, which can be stored in local storage 108 for use by pre-processor 121.

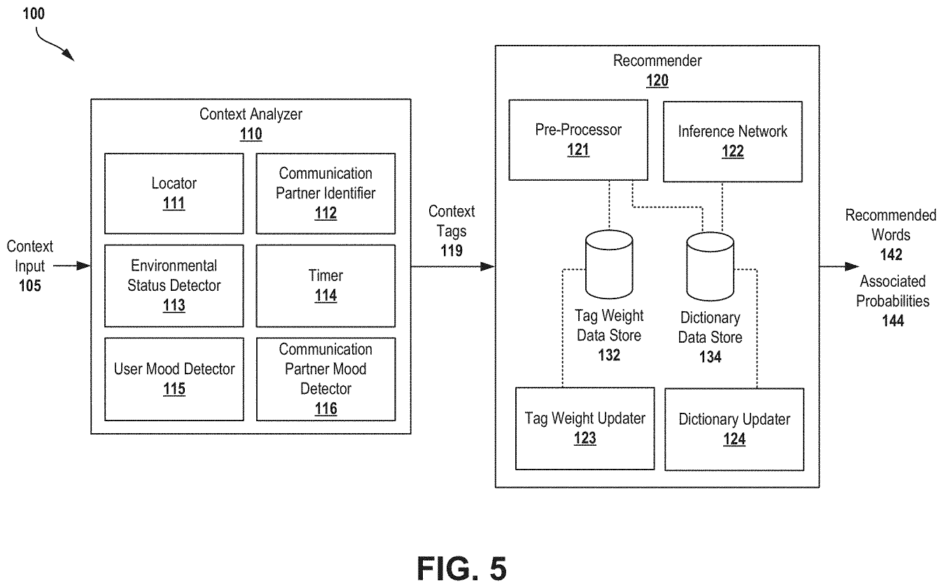

FIG. 5 illustrates system 100 in more detail, in accordance with some embodiments. As shown in FIG. 5, system 100 can include a context analyzer 110 and a recommender 120.

Context analyzer 110 includes a locator 111, a communication partner identifier 112, an environmental status detector 113, a timer 114, a user mood detector 115, and a communication partner mood detector 116.

Context analyzer 110 is configured to generate context tags 119 based on context input 105.

Recommender 120 includes a pre-processor 121, an inference network 122, a tag weight updater 123, a dictionary updater 124, a tag weight data store 132 and a dictionary data store 134. Tag weight data store 132 and dictionary data store 134 can be stored locally, for example, on local storage 108 and/or remotely on remote storage such as cloud storage 109. In some embodiments, the dictionary data store 134 may store content dictionaries (e.g., word dictionaries, phrases dictionaries, icon dictionaries, images dictionaries, audio dictionaries, etc., or any combination thereof), and/or experience dictionaries.

Recommender 120 is configured to generate output 140, including one or more recommended content or experiences 142 and one or more associated probabilities 144 for each recommended content or experience with associated content 142.

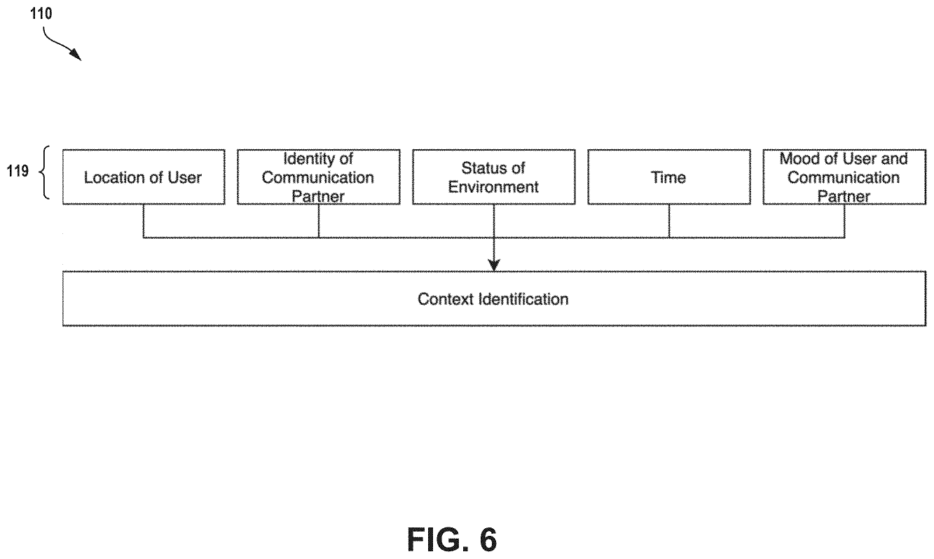

As illustrated in FIG. 6, context tags 119, such as those corresponding to location of user, identity of communication partner, status of environment, time, and mood of user and communication partner, are all examples of context identification generated by context analyzer 110.

Context tags 119 that can be used as input for making recommendations by recommender 120 include:

| Input | Method of Detection | Application |
|---|---|---|
| Location of | GPS, WFPS, 5G | Location based content |
| User | Positioning, Calendar | recommendations |
| | Event | |
| Identity of | Camera, Speaker | Person based content |
| Communication | Recognition, Bluetooth, | recommendations |
| Partner | Calendar Event | |
| Status of | Clock, Ambient Light | Automatic adjustment |
| Environment | Sensor, Weather | of screen brightness |
| | Application Integration, | Automatic adjustment |
| | Detection of | of voice output volume |
| | Communication Partner | Weather based content |
| | Distance, Location | recommendations |
| | Detection (Above) | |
| Time | Calendar Event, | Time based content |
| | System Clock | recommendations |
| Mood of User | Computer Vision | Mood based content |
| | Emotion Recognition, | recommendations |
| | IR Camera Thermal | |
| | Imaging, Speech | |
| | Recognition with NLP | |
| | sentiment analysis | |
| Mood of | Computer Vision | Mood based content |
| Communication | Emotion Recognition, | recommendations |
| Partner | IR Camera Thermal | |
| | Imaging, Speech | |
| | Recognition with | |
| | emotion analysis | |

It may be necessary for a user to grant system 100 permission to access and execute features, e.g., location services to determine the physical location of the user in GPS coordinates, 5G triangulation, or any other location services means. The user may select to grant permission to a combination of inputs such that only a subset of features is implemented by the system. For example, the user may only select to grant the system access to their location and not the identity of their conversation partners.

Context analyzer 110 may also be configured to determine context, for example, context tags 119, based on user preferences.

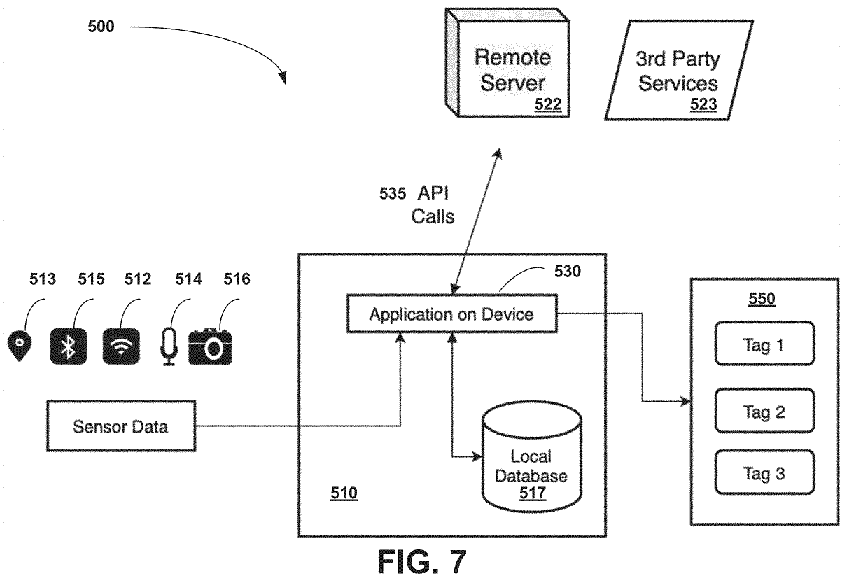

FIG. 7 illustrates the example of the recommended content system environment 500 in more detail, in accordance with some embodiments.

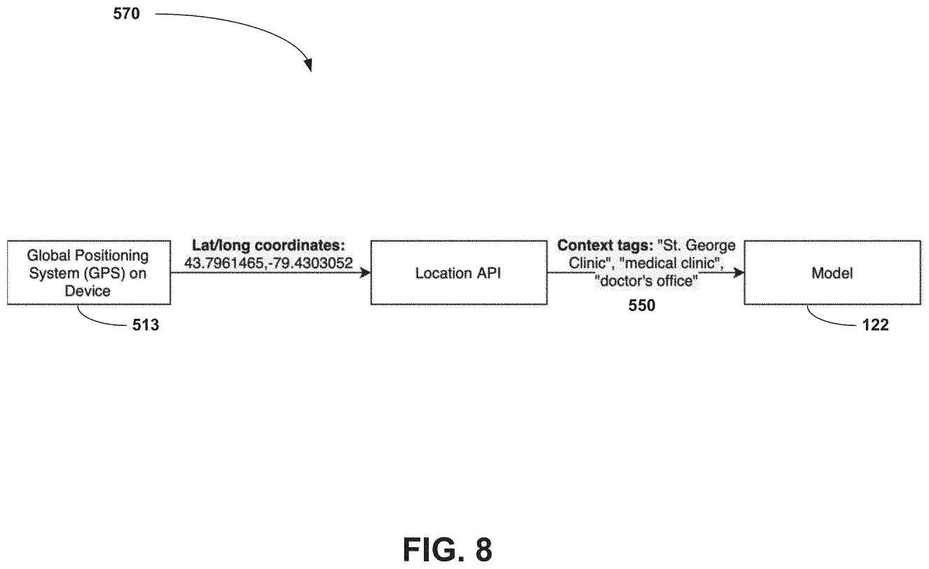

FIG. 8 illustrates an example of location detection 570, in accordance with some embodiments.

The sensors 512, 513, 514, 515, 516 collect context data from the user's environment and device 510, and transmit the data to the application 530 on the device. The application 530 on the device uses a series of API calls 535 to the remote server 522 and 3rd party services 523 to process the context data into human readable tags 550 such as “St. George Clinic”, “Medical Clinic”, and “Doctor's Office”. Several contextual inputs may map to a single tag. For instance, either a calendar event or GPS coordinates, or even the combination of the two inputs may be used to deduce the user's presence at the doctor's office. A collection of tags that are specific to the user and their experiences are stored in their local database 517 and the remote database 521. These tags are determined by the context data acquired from the user's device and these tags may automatically expand over time. For example, if the user frequently visits a new doctor's office called “Finch Walk-in Clinic”, the tag “Finch Walk-in Clinic” may be added to the local and remote databases.

Locator 111 can determine a location of a user as a context tag 119.

Location based context tags 119 can allow for users to access content that they commonly use in specific locations, when they are located at those specific locations. For example, when at the workplace, the user may be presented with content recommendations that are essential to communicating the roles and responsibilities of their position. At a grocery store, the user may be presented with content recommendations that are essential to inquire about the availability of items and their associated prices. These recommendations may be made possible through historical tracking of words that are used at each location. 119 can allow for users to access content that they commonly use in specific locations, when they are located at those specific locations. For example, when at the workplace, the user may be presented with content recommendations that are essential to communicating the roles and responsibilities of their position. At a grocery store, the user may be presented with content recommendations that are essential to inquire about the availability of items and their associated prices. These recommendations may be made possible through historical tracking of words that are used at each location.

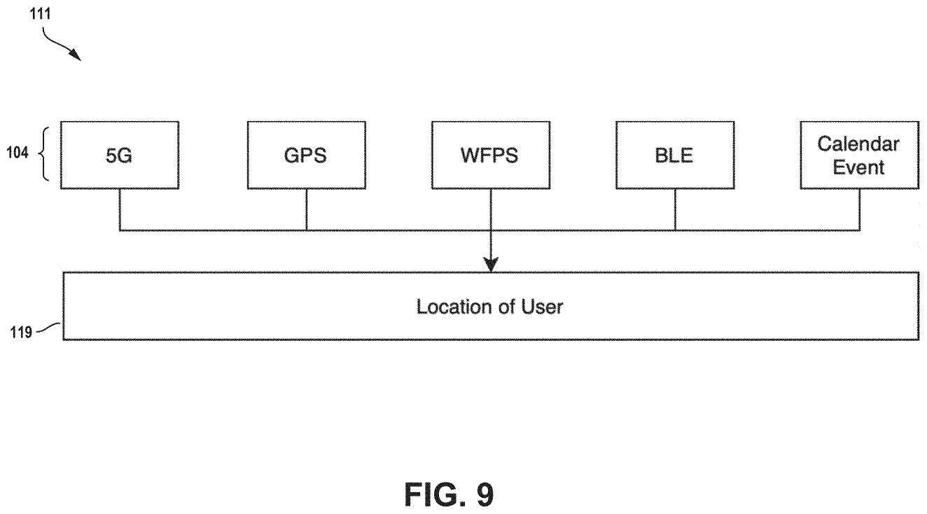

As illustrated in FIG. 9, sensor data such as from inputs 104, including 5G, GPS, WFPS, BLE and calendar event, can be used, alone or in any combination, to determine a location of a user as a context tag 119. Location may be broken down into granular tags indicating a sub-location within a location. For example, a specific aisle in a department store or specific room within a house. In some embodiments, whichever of these techniques the user gives access to and which of these their device/compute environment permits. If different sensors provide contradictory information, all of these may be polled. Redundancy in the sensors help rule out those that are faulty.

In some embodiments, the physical location of a user can be acquired using 5G localization. 5G localization can provide indoor positioning details of the user.

In some embodiments, the physical location of a user can be acquired using GPS on board the system. A GPS signal can provide the latitude and longitude coordinates of the location of the user.

Latitude and longitude coordinates can be inputted to a suitable location service such as the Google Places API, which can provide place details as output, such as establishments, geographic locations, or prominent points of interest. For example, if the place search results in McDonalds, the associated place details may be “McDonalds”, “restaurant”, and/or “fast-food”.

One, or a combination, of outputs from a location service can be used as context tag(s) 119 inputted to a machine learning model such as recommender 120 for location informed content recommendations.

In an example, in the instance that the location corresponds to McDonalds, simply passing in “McDonalds” as the context tag may suffice. This would allow system 100 to access content related to McDonalds, such as menu items and associated images, and present these items to the user in the form of content recommendations.

In an instance that the location corresponds to a less popular place, such as “Pie Eyed Monk Brewery”, a niche brewery, passing in the tags 119 “Pie Eye Monk Brewery”, “restaurant”, and “brewery”, may be necessary. The exact menu items may be difficult to parse and recommend directly to the user. Therefore, the context tags “restaurant” and “brewery” provide more information that help the system access and recommend content with relevance.

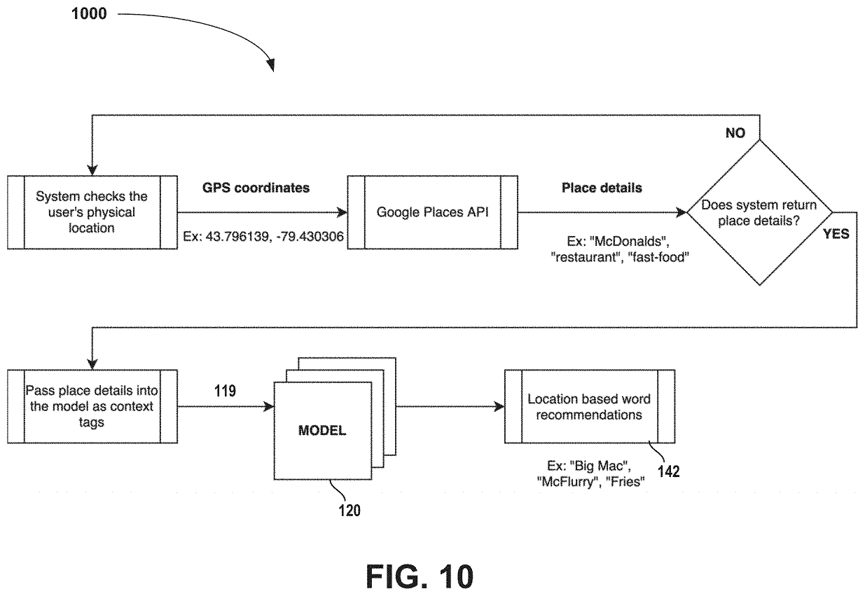

FIG. 10 illustrates an example of a process 1000 performed by locator 111 to use Google Places API to determine a location of a user, in an example. Context tags 119 are generated and input to a model, such as recommender 120, to generate an output 140 including location-based content recommendations 142.

In some embodiments, an API such as MovieDB can allow for additional context to be determined about a location, for example, by retrieving the names of movies that are currently playing and consequently recommend them to the user in order of personal relevance.

A location of a user can also be determined using a Wi-Fi positioning system (WFPS).

Although GPS can be sufficient for determining the position of outdoor elements, it is not well equipped to determine the position of indoor elements.

The precise position of an indoor element can be determined using Wi-Fi. Received Signal Strength Indicator can determine the distance of the indoor element from the wireless access point. This allows for generating location-based context tags 119, such as specific rooms within the home (kitchen, bedroom), or specific rooms at school (math classroom, principal's office), etc.

A location of a user can also be determined using Bluetooth Low Energy (BLE) techniques. BLE is also an option that may be used for indoor positioning.

A BLE beacon is a hardware device that is capable of communicating information to other devices with Bluetooth capability, such as a tablet.

A Bluetooth beacon situated in an indoor location that is frequented by the user, communicates a location identifier to system 100, allowing for the generation of a location-based context tag 119. For example, a BLE beacon in the user's kitchen allows locator 111 to recognize when the user is in the kitchen based on proximity to the BLE beacon. System 100 may consequently recommend content to the user that would be useful for them to access in the kitchen, and keep track of the content that the user commonly speaks in the kitchen.

A location of a user can also be determined using a calendar event.

System 100 may also be alerted of where the user will be at a specific time based on their calendar. This is based on the assumption that the user enters where they will be at specific times in their calendar, and that locator 111 has access to the user's calendar.

Communication partner identifier 112 can determine an identity of a communication partner as a context tag 119.

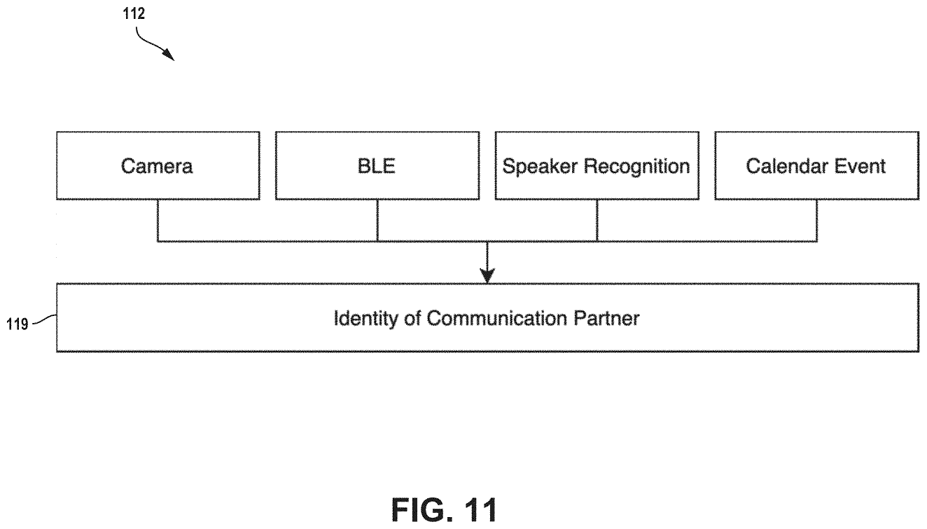

Communication partner identifier 112 can be configured to detect the identity of the communication partner, such as their name, and use historical content usage data from the system to recommend content that is relevant to the relationship that comprises both individuals. This detection of communication partner may occur using one, or a combination, of the techniques illustrated in FIG. 11. In some embodiments, whichever of these techniques the user gives access to and which of these their device/compute environment permits. If different sensors provide contradictory information, all of these may be polled. Redundancy in the sensors help rule out those that are faulty.

As shown in FIG. 11, data from a camera, BLE, speaker recognition and calendar event can be used, alone or in any combination, to determine an identity of a communication partner as a context tag 119.

An identity of a communication partner can be determined using an outward facing camera.

Existing computer vision (CV) techniques, including facial recognition, may be used to assign a person's name to a detected face. That identity may then be stored in a database as a vector linked to the name. With the CV algorithm running on the interface's outward facing camera, communication partner identifier 112 has the ability to automatically detect the identity of the individual when their face enters the frame and recommender 120 can consequently recommend words or phrases that are relevant to their relationship based on previous conversations that have occurred between the two individuals. This is done by tracking the user's utterances during times when that conversation partner's face was previously detected by the system, thereby indicating that they were having a conversation. System 100 may either require the user to select when they would like to start detecting a new face, or notify the user when a new face is detected and ask if they would like to store it for future recognition. In some embodiments, images are not stored of the communication partner, which may eliminate certain data privacy concerns. The vector generated to depict an image of the face may be irreversible and as such also alleviate certain privacy concerns. These vectors are associated with an ID and a name, the name may be stored locally on the user's device while the ID and vectors are backed up on the cloud. This may reduce the threat of correlating vectors to an identity if the cloud data is ever compromised.

An identity of a communication partner can be determined using a BLE beacon.

Although a BLE beacon may be used to provide location information, they can also be programmed to transmit a personal identifier that is linked to a specific person.

Smartphones are capable of being turned into BLE beacons.

This solution would require a communication partner to download an app on their phone; the app runs in the background, allowing the phone to be recognized as a beacon by the user's SGD. The beacon, or phone, sends the beacon's identifier to the device which is linked to the beacon user's name and associated word lists.

Overall, this solution allows the user's system to detect the presence of a communication partner, update the system context, and recommend appropriate content (such as words and phrases) to the user based on historical conversations with that communication partner.

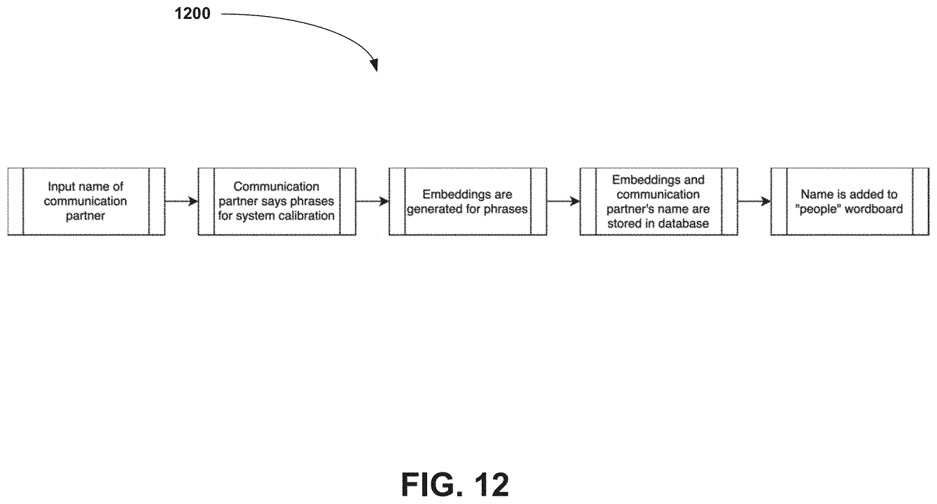

An identity of a communication partner can be determined using speaker recognition. FIG. 12 illustrates an example of a process 1200 performed by communication partner identifier 112 to add a new communication partner.

The identity of the communication partner may be acquired using speaker identification through speech recognition. Communication partners will be asked to calibrate their voices through the system. In some embodiments, these voice recordings or future voice recordings are not stored in their raw condition, and only processed metadata is stored in any capacity.

To add a new voice to the system, communication partner identifier 112 requests communication partners to say a series of short phrases via microphone input. These phrases will be converted to embedding vectors through a machine learning algorithm. The communication partner can then input their name to the system to create an association between the voice and name. The name and associated voice embeddings can be stored in a database and can be made available in the user's content collection.

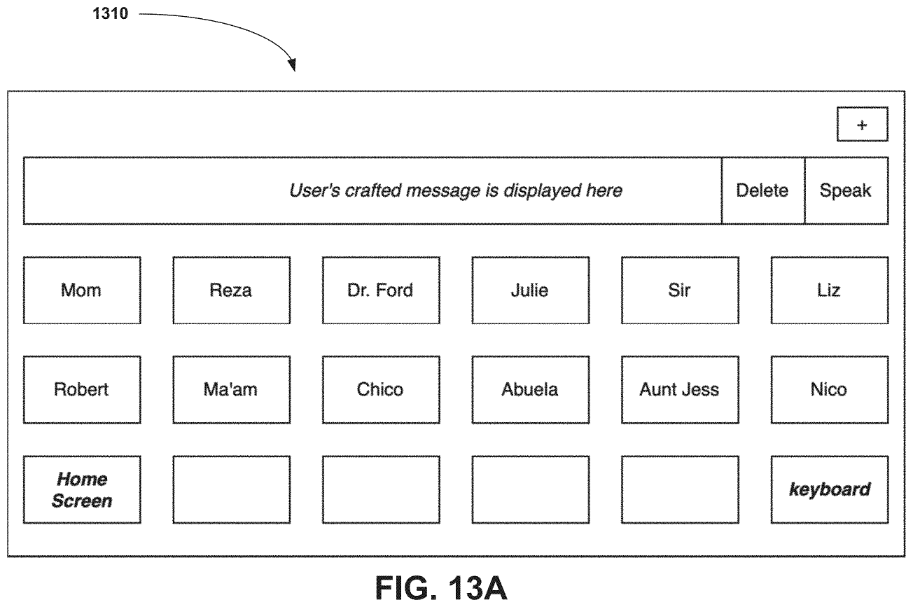

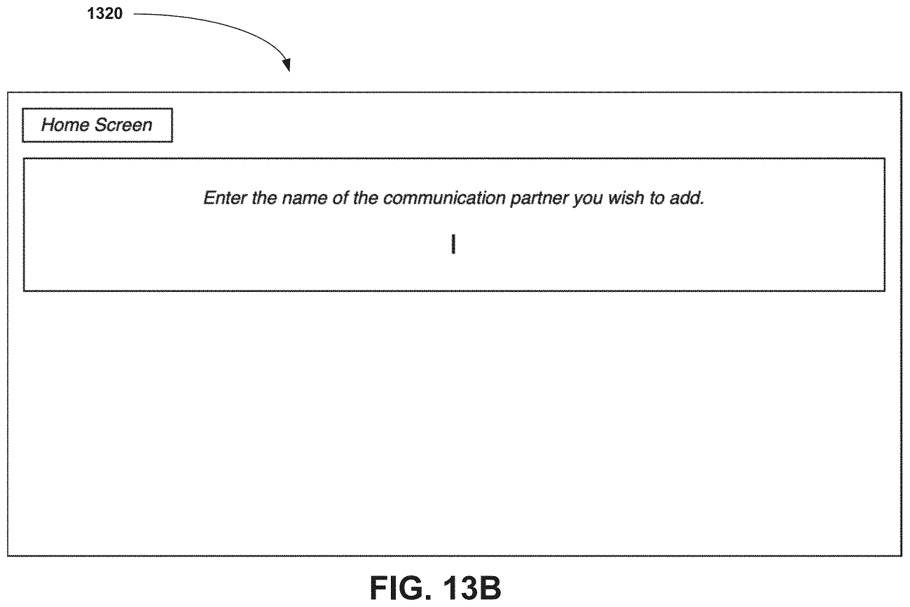

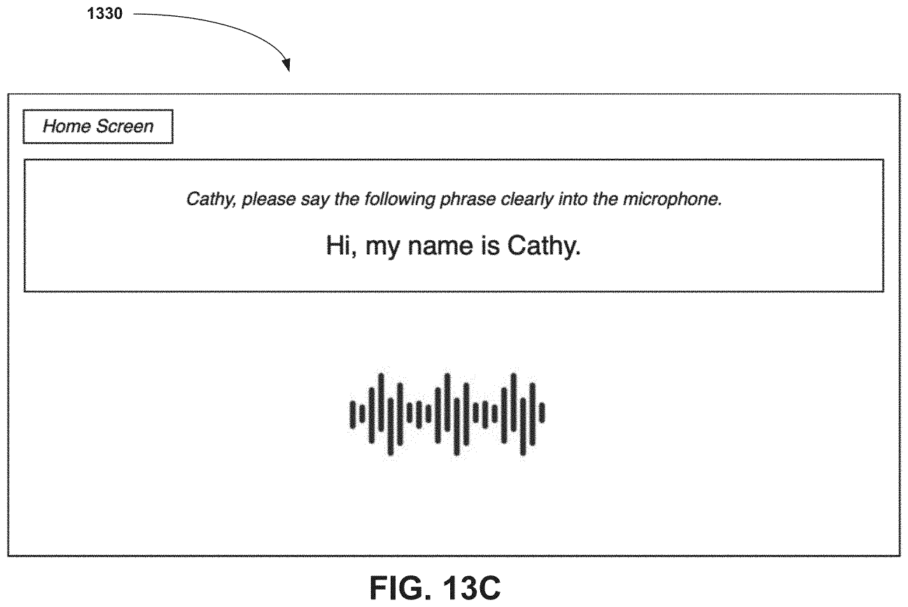

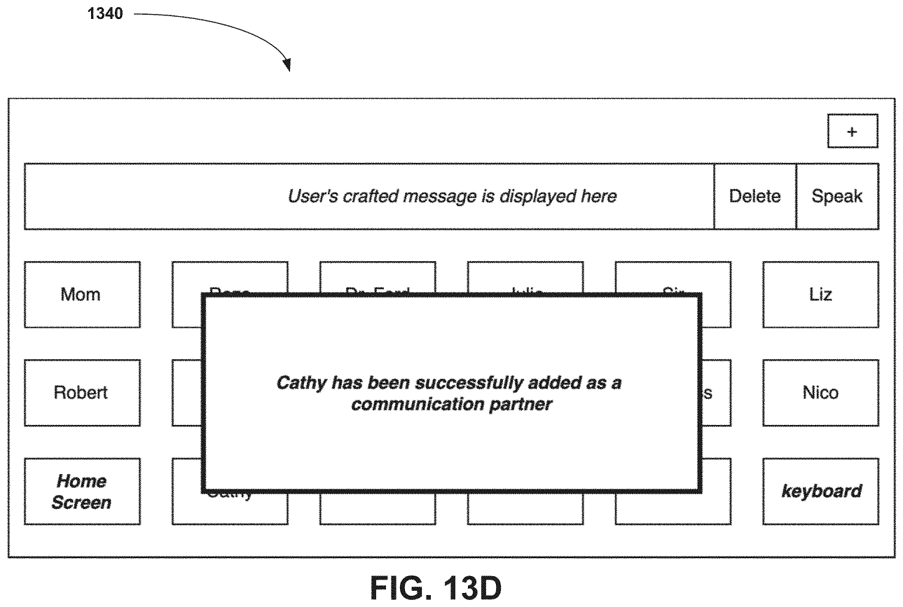

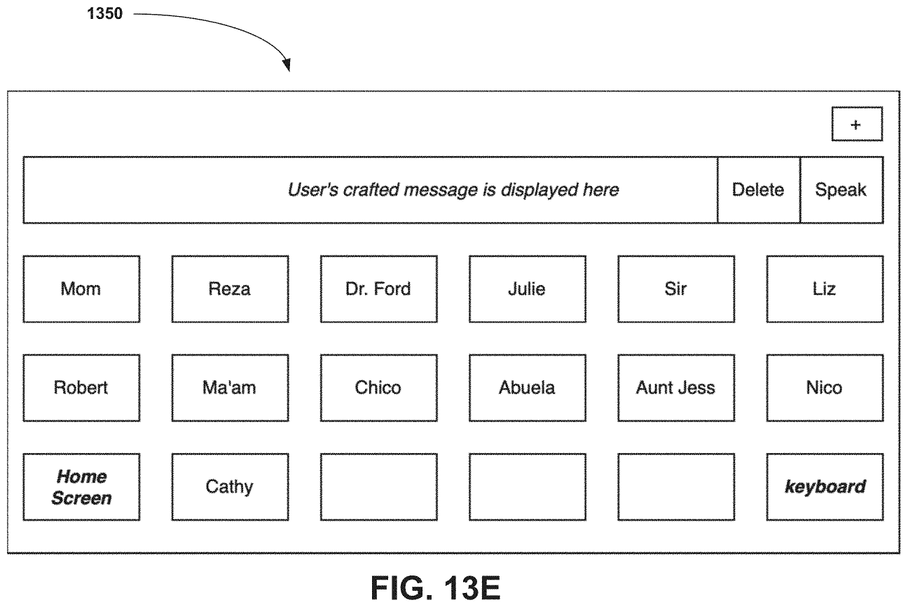

A wireframe workflow for adding a new communication partner is illustrated by way of screenshots in FIGS. 13A-13E.

Pattern recognition techniques, including speaker recognition, may be applied to identify the communication partner based on characteristics from their voice [21].

Communication partner identifier 112 may either require a user to select when they would like to start detecting a new voice, or notify the user when a new voice is detected and ask if they would like to store it for future recognition. The former option may be desirable as the user may have a specific list of individuals who they would like to have personalized conversations with.

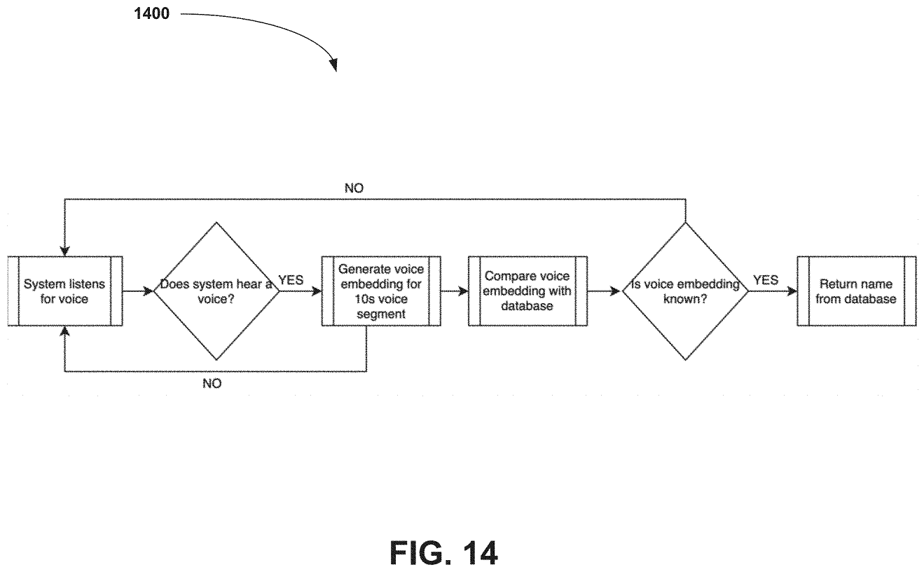

FIG. 14 illustrates an example of a process 1400 performed by communication partner identifier 112 to identify a communication partner, using speaker recognition, according to an embodiment.

The process illustrated in FIG. 14 outlines the process of identifying whether the current speaker is a known communication partner who has inputted their voice and name through the addition process (outlined above).

The microphone will listen for a voice every short interval (this can be anywhere from 30 seconds to 5 minutes).

Every interval, a short 10 second segment of the voice input will be passed to the speaker identification machine learning model to generate a voice embedding, such as a digital voice (communication partner's voice).

This voice embedding can be compared with the remaining embeddings in the system to identify the speaker. K-Nearest clustering will be used to identify the closest embedding and thus the most likely known speaker.

The name of the identified speaker will be returned back as a context tag 119. For example, if Cathy is speaking at the time the microphone is listening for voice input, her name will be returned as the tag “Cathy”.

An identity of a communication partner can be determined using a calendar event.

Communication partner identifier 112 may also be alerted of who the user will be with at a specific time based on their calendar. This is based on the assumption that the user enters who they are meeting with at specific times in their calendar, and that system 100 has access to the user's calendar.

Environmental status detector 113 can determine a status of environment as a context tag 119.

One factor that can provide insight into environmental status is weather. Other factors may include environmental sound data which can inform output voice volume, and environmental light data which can inform the screen brightness.

The physical location of the user can be used in conjunction with a weather API, such as Weather API by OpenWeatherMap, to access current weather data or forecast data. The description output of the Weather API can provide content in the form of descriptive words such as “Sunny”, “Cloudy”, “Cold”, “Warm”, etc.

These outputs will be used as context tags 119 that are inputted to a machine learning model, such as recommender 120, for weather informed content recommendations.

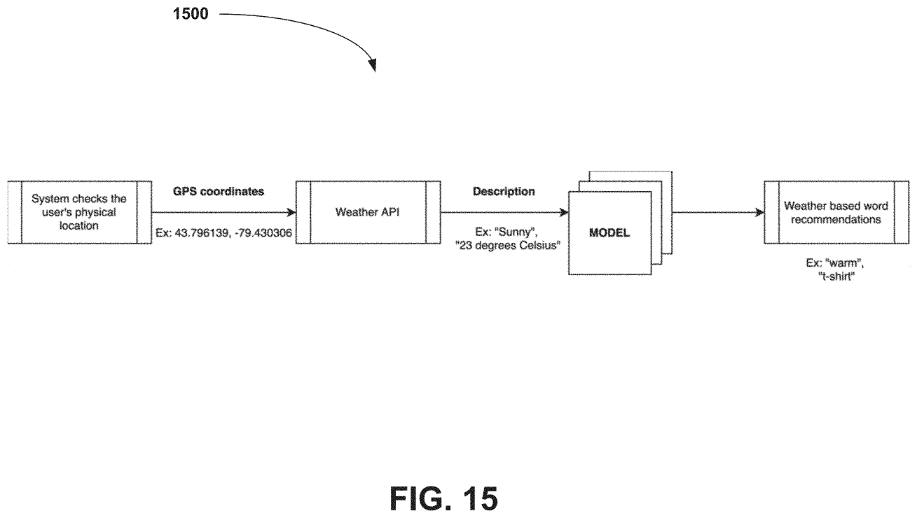

FIG. 15 illustrates an example of a process 1500 performed by environmental status detector 113 to determine a status of environment, according to an embodiment.

Timer 114 can determine a time as a context tag 119.

The user's schedule may be (1) programmed into system 100, (2) synched from the user's calendar (such as Apple Calendar, or Google Calendar), or (3) inferred through use of an algorithm that recognizes patterns of speech throughout the user's day. An example scenario depicting what a user might say at various times throughout the day is displayed in the table below:

| Time | Sample Phrases |
|---|---|
| 8 AM - User wakes up | “Good morning sweetheart”, “I am going |
| | to brush my teeth”, “Can I use the |
| | bathroom first?” |
| 8:30 AM - User eats | “Do you want eggs with that?”, “The toast |
| breakfast | is burnt”, “Orange juice, please”, “I'll do |
| | the dishes”, “Hungry?” |
| 9 AM - User commutes | “Come on, it's time to go, I can't be late |
| to work | again”, “Is Daniel already in the car?” |
| 9:30 AM - User arrives | “Hello Carl”, “How was your weekend?” |
| at work | |

Time based tags can be determined through calendar events, including duration of calendar events. Calendar event title and description, and in some embodiments, duration, will be provided to a topic modelling network as input text. This can determine the key event-based phrases in the input text and provide the key phrases as output.

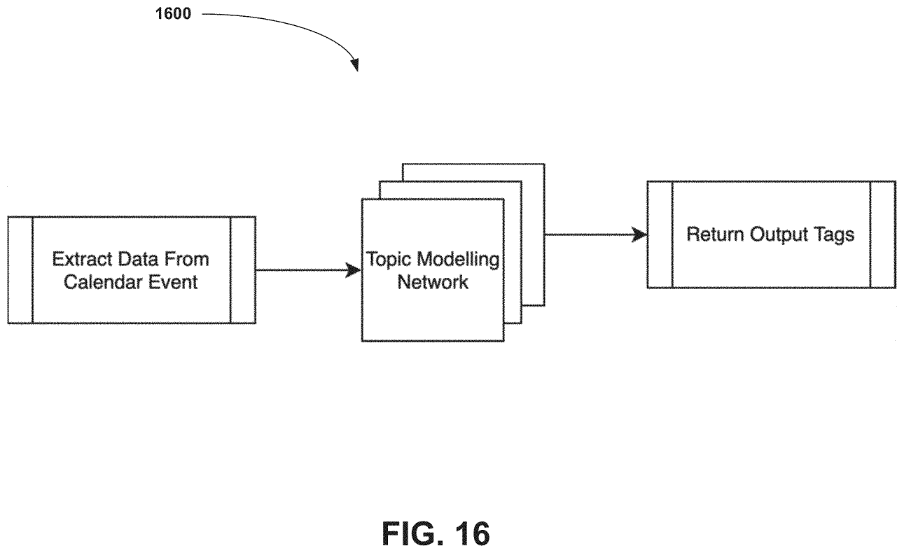

An example of a workflow 1600 of extracting context tags from calendar events is illustrated in FIG. 16. Below is an example of the process:

In some embodiments, system 100 also includes recommender 120, configured to generate a list of recommended content, given context tags 119 generated by context analyzer 110. Once context tags are determined by context analyzer 110 they are passed to recommender 120, which can include a machine learning framework.

Context tags may include, Event Title: “Marketing Meeting” Location: “Room 402”; Attendees: “Sheila” and “Steve”; Event Description: “Discussion regarding key features to add in branding material for next software release”.

The topic modelling framework can pick up key words such as “Marketing Meeting”, “Room 402”, “Sheila”, “Steve” and “software”. These words can then be passed as context tags 119 to recommender 120.

User mood detector 115 can determine a user mood as a context tag 119. The mood of the user can be classified through varying means including image-based input, emotional analysis of text and voice input.

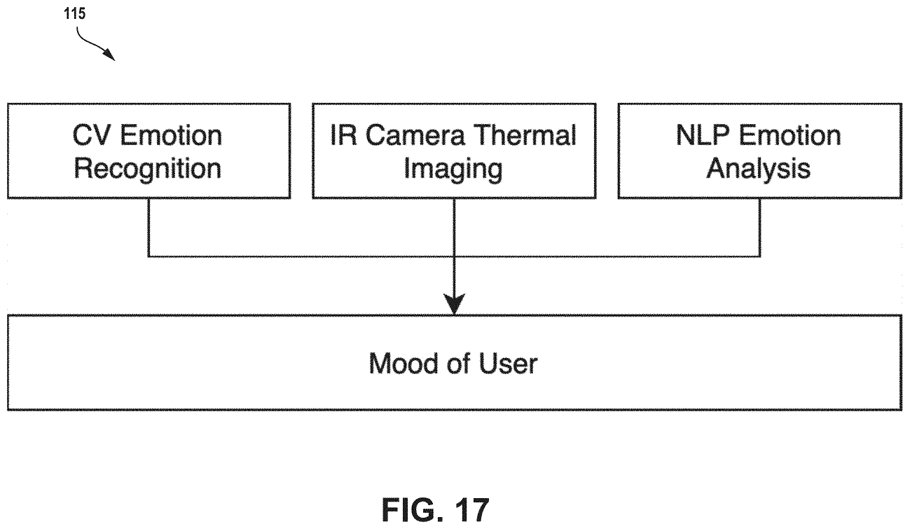

Detection of user mood may occur using one, or a combination, of the following three example techniques illustrated in FIG. 17, including CV emotion recognition, IR camera thermal imaging, and NLP emotion analysis. In some embodiments, whichever of these techniques the user gives access to and which of these their device/compute environment permits. If different sensors provide contradictory information, all of these may be polled. Redundancy in the sensors help rule out those that are faulty.

CV techniques may be applied, for example, using a frontward facing camera, to perform facial recognition and consequent emotion recognition. This is accomplished by analyzing features in the face that may change depending on the user's emotion. The success of this method relies on the user's ability to control the muscles in their face, which may not be possible in all cases due to a physical disability such as paralysis following a stroke.

Images will be acquired at a fixed interval. These images will then be passed to a mood classification network to classify the user's mood. Sample mood context tags 119 include “happy”, “sad”, “angry” and “fearful”. Tags 119 can then be passed to recommender 120.

If the interface contains a front facing IR camera, such as certain models of the iPhone, it may be leveraged to perform thermal imaging. Thermal facial images have been analyzed in research to detect emotions using a heat map spread across the face. Excitement can trigger a warm spread across the face, while face temperature can drop suddenly when a person is startled. Application of this method may allow for emotionally relevant words and phrases to be recommended to the user.

An NLP technique called emotion analysis may be applied to identify the emotional intent of messages that are being constructed by the user (such as happiness, anger, sadness, etc.). This detection may allow for emotionally relevant words and phrases to be recommended to the user as they continue to craft their message.

Emotion analysis can be performed on text and/or voice input.

Emotion analysis can also be applied on user crafted messages to identify the mood of the user and thus return context tags 119 depicting the emotional situation

Communication partner mood detector 116 can determine a mood of a communication partner as a context tag 119. The mood of the user can be classified through varying means including image-based input, emotional analysis of text and voice input.

Mood detection of the communication partner may also act as an input that can inform the types of content the user requires access to. For example, the communication partner may outwardly express sadness. The SGD user may want to be able to ask the communication partner why they are feeling sad, and provide comfort to them. Recognition of the communication partner's mood based on their expressed emotions, would allow the user to receive word and phrase recommendations that are aware of such emotions.

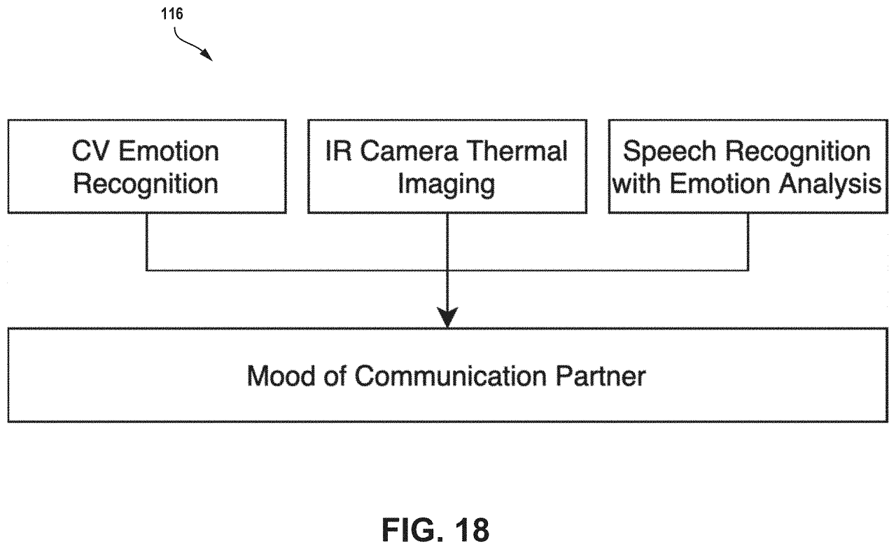

Detection of communication partner mood may occur using one, or a combination, of the following three example techniques shown in FIG. 18, CV emotion recognition, IR camera thermal imaging, and speech recognition with emotion analysis. In some embodiments, whichever of these techniques the user gives access to and which of these their device/compute environment permits. If different sensors provide contradictory information, all of these may be polled. Redundancy in the sensors help rule out those that are faulty.

Outward facing camera functionality may operate in a similar manner to the CV techniques described above with reference to a frontward facing camera used with user mood detector 115. In some embodiments, instead of leveraging the camera that faces the user, an outward facing camera directed at the communication partner is used.

Outward facing IR camera functionality may operate in a similar manner to the thermal imaging techniques described above with reference to a frontward facing infrared camera used with user mood detector 115. In some embodiments, instead of leveraging a camera that faces the user, an outward facing camera directed at the communication partner is used.

Emotion analysis functionality may operate in a similar manner to emotion analysis techniques described above with reference to user mood detector 115. In some embodiments, instead of running emotion analysis on the words that are selected by the user, emotion analysis can be run on the speech of the communication partner through the use of speech recognition. This may require use of a microphone.

Communication partner consent may be required in order to perform speech analysis. For speech-based input, this consent can be acquired during the process of adding their name and voice to the speaker identification list. Emotion analysis can be applied with speech recognition to identify the mood of the communication partner and return corresponding tags.

The system defined content associated with each context is determined through the use of a content recommender. The content recommender includes a preprocessor and an inference network which may be embodied by a machine learning framework.

Inference network can generate an output, including recommended content and associated probabilities. Inference network can further return “feedback”, including updated context tag weights and new content determined by tag weight updater and dictionary updater, respectively, and which can be stored in local storage for use by the inference network.

The inference network may additionally be initialized from a crowd-sourced corpus of training data which encompasses general context tags with associated content or context tags corresponding to general experiences with associated content. This may encompass general content a user may require. For example, at a restaurant location, general content may include “I'm ready to order”, “Thank you”, etc. The user's model may then be automatically fine-tuned based on their personal usage.

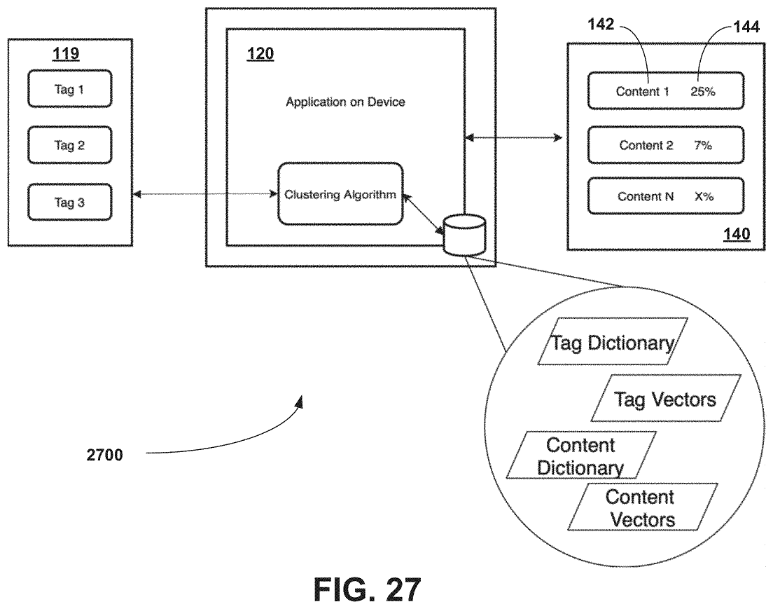

FIG. 27 illustrates an example of a content recommender inference process 2700, in accordance with some embodiments. The content recommender includes a pre-processor, an inference network, a tag and content weight updater, a tag and content dictionary updater, a tag and content weight data store, and a tag and content dictionary data store. All of the aforementioned data stores can be stored locally, for example, on local storage and/or remotely on remote storage such as cloud storage.

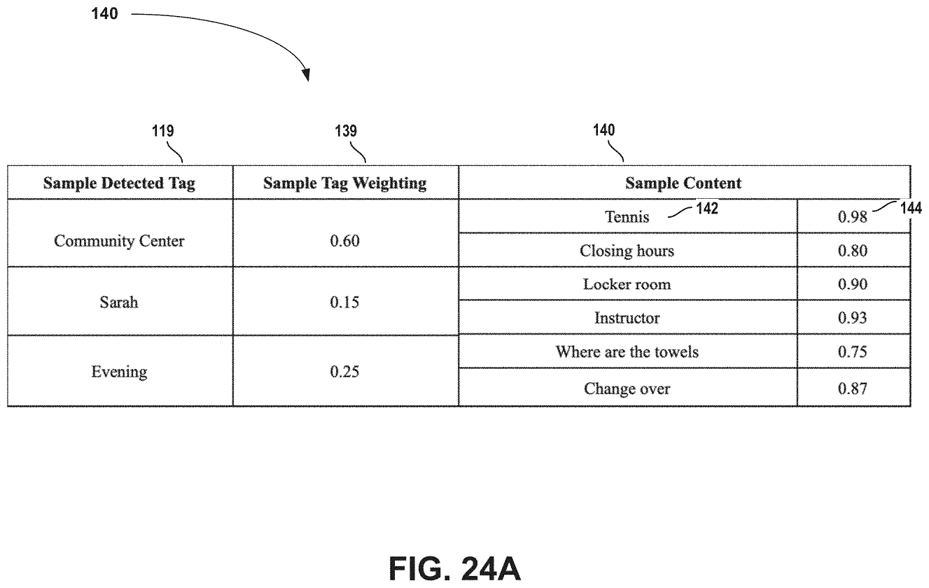

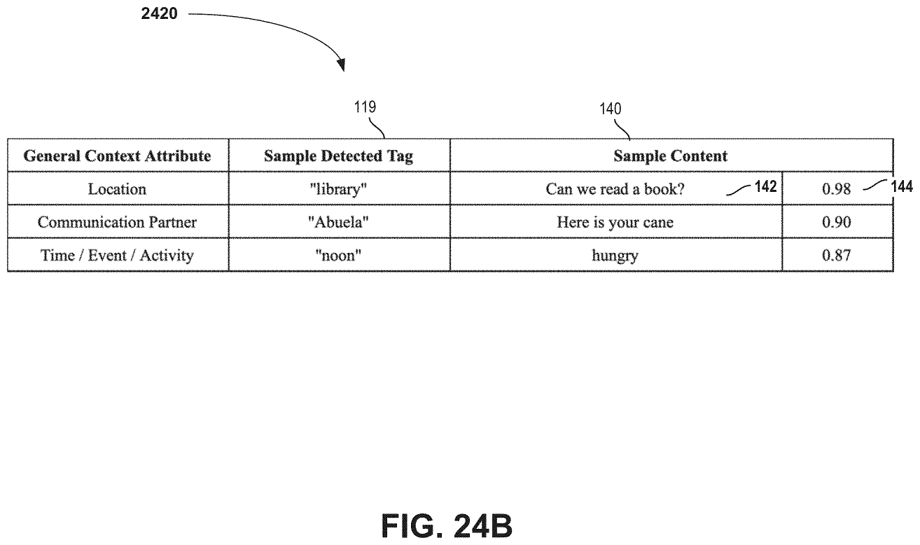

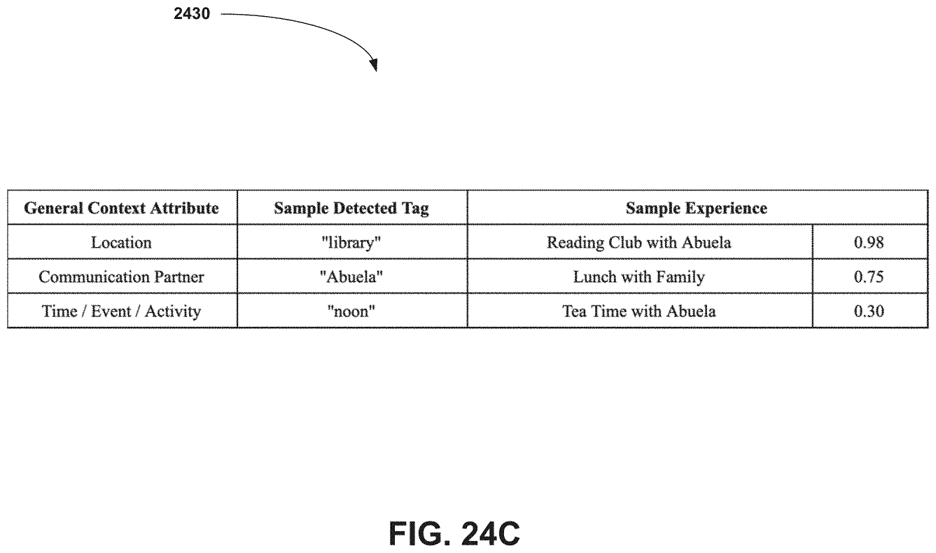

Context tags 119 are passed to recommender 120, in an example, a machine learning framework, in order to generate a list of potential content that are related to these tags, in an example, an output 140 including content recommendations 142 and associated probabilities 144. For example, a context tag 119 “Kitchen” may be correlated to the recommended content 142 such as the following words and phrases: fork, pasta, “I'm hungry”, “what's cooking”, pizza, spoon, napkin, tasty, and smell. This also applies to combinations of context tags 119. The tags Community Centre, Sarah and Evening may produce the words tennis, closing hours, locker, schedule and instructor. An example is demonstrated in FIG. 24A.

In theory such a process could generate an endless list of content. The likelihood that all the content would be relevant in the given context is represented by a probability. Additionally, not all tags 119 may have equal weight in determining which content is relevant to a user; some tags 119 may have greater weight than others. Weights 139 are thus associated with each tag 119 and are learned through the machine learning model from usage history. Tag weights 139 may take into account the frequency of use of each content associated with combinations of each tag 119, and thus the likelihood that a content will be used in a certain context. Tag weights can be stored in tag weight store 132.

The nature of the frequency factor also allows for the system to accept that users may have dynamically changing conversations; although certain content may have been frequently used in a given context in the past, that may not be the case in the present. Normalization is performed on the frequency map in order to uphold this consideration. For example, User A may have frequently used the word pasta while in the Kitchen with their mom during lunch 7 months ago, but since their favourite food has changed to pizza and the frequency of use has increased in the defined context, pizza (0.95) will take precedence to pasta (0.63).

Content, such as any combination of recommended words, phrases, icons, images or audio 142, are recommended to the user based on context, such as with context tags 119. The context is established through a combination of attributes including but not limited to location, communication partner and nature of event or activity. The machine learning algorithm accepts input tags which are descriptors of the context and outputs a list of content with an associated confidence metric for each content. An example 2420 of input context tags 119 and corresponding output 140 including recommended content 142 and associated probabilities 144 is illustrated in FIG. 24B. FIG. 24C is another example 2430 of input context tags and corresponding recommended experiences and associated probabilities, in accordance with some embodiments.

Content recommendations can be provided to the user according to a combination of two key factors: desired or selected context and historical content use frequency.

The relevance of content recommendations is partially determined by the likelihood of use of each content based on the detected or selected context and as determined by recommender 120.

Context tags 119 are accepted by pre-processor 121. Preprocessor 121 uses a word embedding algorithm to correlate the tags with words and phrases of semantic relevance. An image embedding algorithm may be used to correlate the tags with icons and images. Semantic relevance may be defined as the relation between content based on meaning. For instance, the tag “Marketing Meeting” would have a high semantic relation to content such as “minutes”, “roll-out” and “agenda” as opposed to “dog”, “gym” and “pajamas”. Examples of such word embedding algorithms include Word2Vector, GloVe and FastText. The word embedding algorithm may be trained using open-source data such as Twitter datasets, curated conversational datasets, or continuous system usage. The image embedding algorithm is trained through user-specific, continued system usage. The relation between tags and images is primarily informed by the frequency of use within context.

A local collection of content (e.g., words) can be used for reference. This collection of words is referred to as a dictionary, and can be stored in dictionary data store 134. This dictionary contains content that is locally available on the user's device and accessible through their system interface. Through the selected word embedding algorithm, a vector is produced to describe each context tag's 119 semantic relevance to each content in this dictionary. Cosine similarity is used to describe each dictionary content's word's semantic relevance to a context tag.

An embedding algorithm transforms a tag to an embedding vector

ī=(w_{d0}, . . . ,w_{dk})

where k represents the size of the vector. Embeddings convert a tag to a low dimensional vector where the closeness of vectors indicate high relation. Any content in the dictionary also has an associated vector such as

n̅=(w_{q0}, . . . w_{qk})

The cosine similarity between the tag and content can be described as follows:

$$Cosine Similarity ( \overline{i} , \overline{n} ) = \frac{\overline{i} \cdot \overline{n}}{\vert \overline{i} \vert \vert \overline{n} \vert} = \frac{{\sum }_{i = 1}^{k} {w}_{qk} \times {w}_{dk} }{\sqrt{{\sum }_{i = 1}^{k} {( {w}_{qk} )}^{2}} \cdot \sqrt{{\sum }_{i = 1}^{k} {( {w}_{dk} )}^{2}}}$$

Again, it should be noted that the cosine similarity metric is used for illustrative purposes. Any similarity metric may be used.

N (20<=N<=100) content with the highest cosine similarity to the context tag make up a vector that is passed to the network. N is an experimental value determined through trial and error and will be verified through testing and validation. The values in this vector are then normalized such that the sum of the elements in the vector equals one.

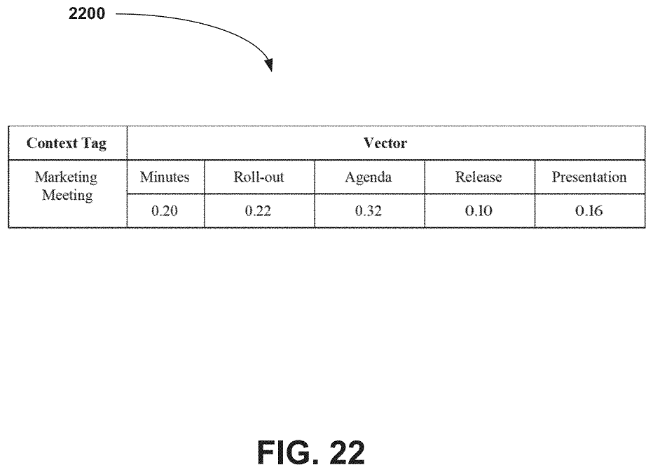

An example of a vector 2200 where N=5 is provided in FIG. 22 for illustration purposes. Based on the results from cosine similarity, the tag vector indicates that the word “agenda” in the content dictionary is the most relevant content to marketing meeting tag. This is indicated by the highest normalized cosine similarity value in the vector at the index that corresponds to the word “agenda” in the content dictionary.

Recommender 120 also includes an inference network 122.

The tag vectors and the content embeddings are cached in the local database and are backed up in the remote database with an associated encrypted user ID. If the experience has a high match with the tags, only the content associated with those tags are retrieved from the content dictionary and displayed on the application. Content associated with highly relevant experiences are displayed at a higher priority than experiences that match with a lower priority.

System 100 may be configured to automatically detect any changes in context based on the recorded inputs. For example, the user may move from their bedroom to the bathroom, depicting a change in context due to a change in location. System 100 can update the content recommendations displayed to the interface to reflect the change in context. The previously recommended content may have included words and accompanying images, such as: bed, blanket, and sleep. The updated recommendations may include: toothbrush, shower, and makeup.

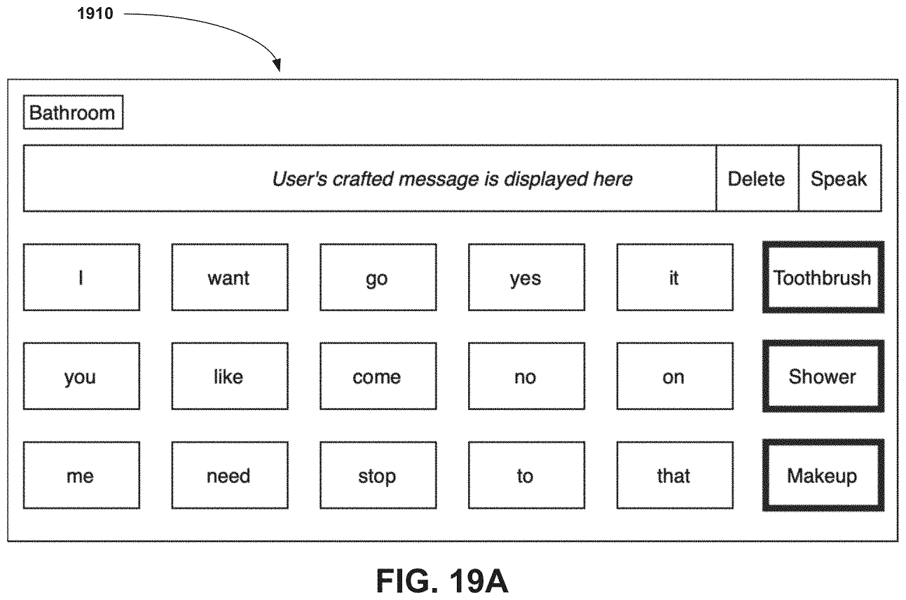

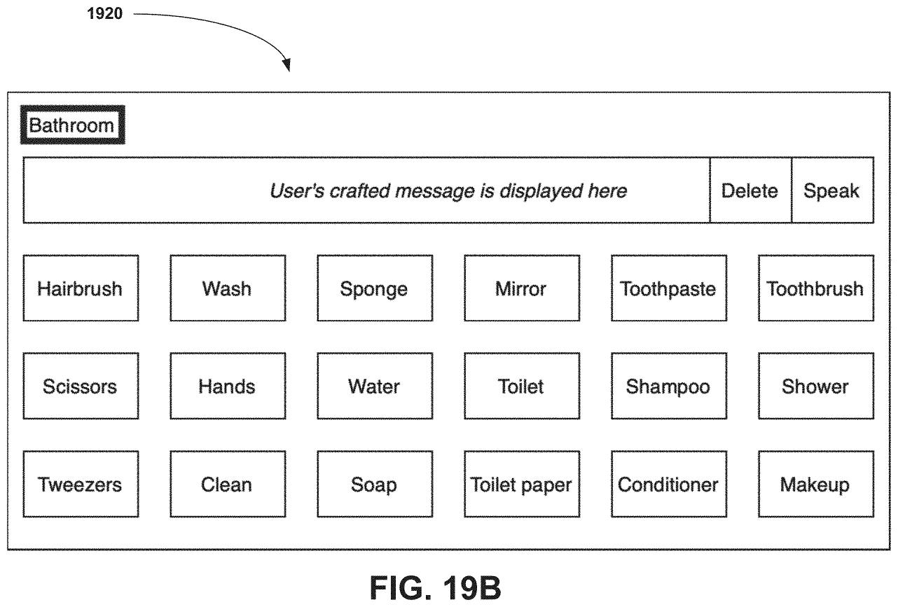

FIG. 19A depicts a screenshot 1910 depicting an example of a context tag 119, “Bathroom” and associated recommendation words 142. The current context: “Bathroom” is displayed on the top left of the screen, and the word recommendations 142 are shown in blue on the right side of the screen.

Although system 100 works to optimize the recommendations, and ensure that the most relevant selections are displayed to the user, the user may still require to access more words related to the specific context.

For example, the user may want to ask for their toothbrush, but also ask for toothpaste, which is not currently displayed in their recommendations. All additional words related to the bathroom context can be accessed by clicking on the bathroom button located on the top left of the screen. The consequent word board 1920 that would be displayed for the bathroom is shown in FIG. 19B. To navigate back to the main screen, the user may click on the “bathroom” button again which will unselect it. In some embodiments, a recommendation of relevant folders (e.g., a reference link to the relevant folders) for quick access to more words and/or phrases may be provided on a main screen. In some embodiments, folders correspond with experiences. It should be noted that different experiences (i.e., folders) may have copies or links to similar content and their corresponding tags.

System 100 can also provide the option for the user to select when the context, and hence context tags 119, is updated, instead of being automatically updated. This can prevent the user from experiencing confusion and frustration when the experience recommendations are automatically updated. It provides the user with control over these system changes.

Context can be updated by a user pressing a button, or a change in context being automatically detected.

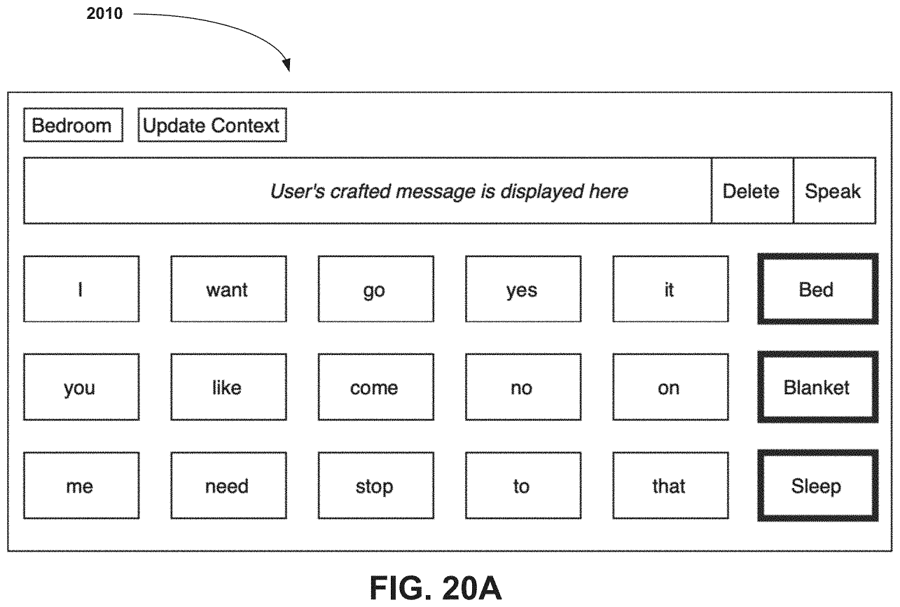

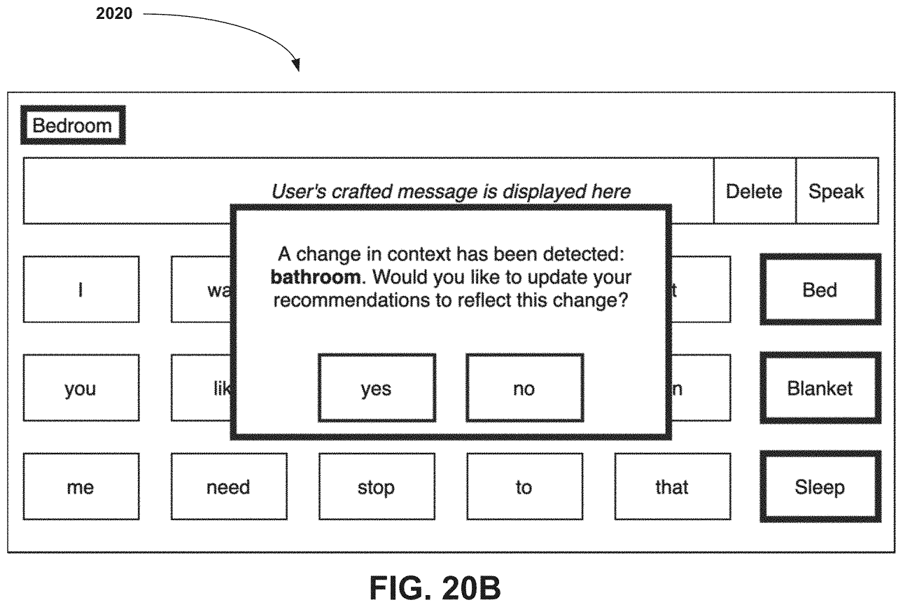

In some embodiments, a user can press a button, for example, labeled “Update Context”, to update a context and recommended experiences 119. Upon pressing the button, system 100 assesses the inputs to determine any change in context, using techniques disclosed herein. In some embodiments, any change in context tags 119 can be reflected in the context bar at the top of a software interface 2010 and in the resulting recommendations shown on the interface, shown by way of example in FIG. 20A.

System 100 can also automatically detect changes in context and provide a popup on the user's screen that reads: “A change in context has been detected. Would you like to update your recommendations to reflect this change?” Therefore, the user must grant access for the system to change the context and consequently update the recommendations to match. In some embodiments, this change may be reflected in the context bar at the top of the software interface. This feature is shown in a screenshot 2020 by way of example in FIG. 20B, illustrating a pop-up prompt to update to a detected context.

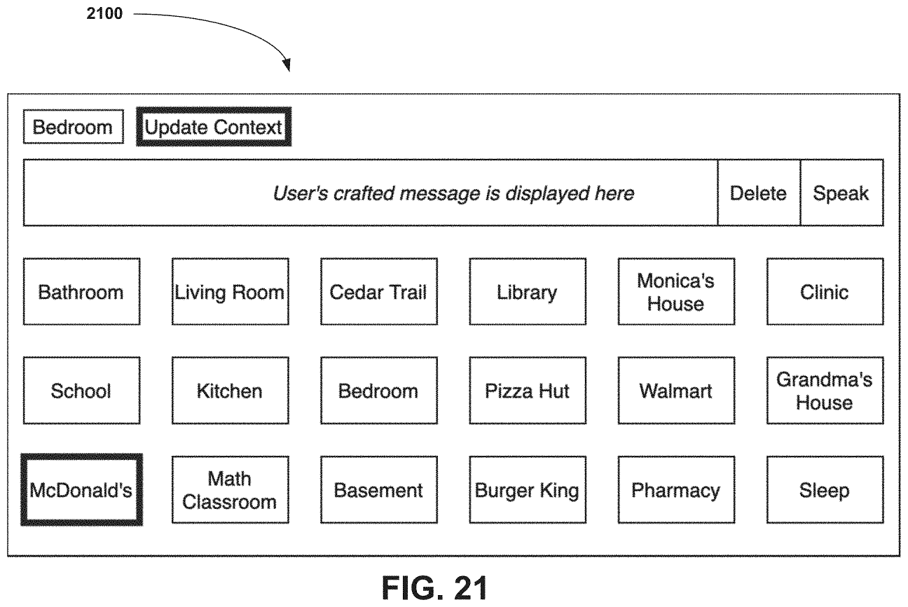

System 100 can also provide the option for the user to manually select their situation context, instead of automatically updating the context to their current situation. This will allow the user to access words associated with a specific context, even when the user is not in that context. For example, the user may want to access their favourite order from McDonald's so they can tell their mom to order it for them on her way back from the grocery store. Even though the user is not at McDonald's, they can select McDonald's as the location context and receive content recommendations that include their favourite menu items. This feature is shown in a screenshot 2100 by way of example in FIG. 21. The user may update the context by clicking on the “Update Context” button. Upon the click, the user is taken to a new content board containing all of their relevant contexts, prioritized based on the processing algorithm, to ensure that the most relevant contexts are the most easily accessible to the user.

A list of recommended content 142 and probability of relevance 144 in a given context plays a large role in the recommendations displayed to the user. Given the context as input tags 119, recommender 120 outputs a list of relevant content with associated probabilities as to how relevant they are to the given situation. If a user is in their math class and is speaking with their caregiver during a test, content deemed as most relevant to this context such as the words “divide” (0.98), “quotient” (0.97), and “factor of” (0.93) will be displayed to the user. In some embodiments, the content recommendations may be provided through on or more recommended experiences, such as “Math Class” or “Taking a Test”.

In some embodiments, the system may recommend one or more full phrases to the user based on an input selection of at least one word or icon/image and the detection of related context tags. For example, a user may typically walk their dog in the morning on days when the weather is dry. The user may select the word and/or accompanying icon/image for “dog” on their system. The system may infer, through the combination of the input selection of “dog”, the detection of a time context tag that describes it is currently morning and a weather context tag that describes it is currently dry, that the user would like to communicate that they are going to walk the dog. The system may recommend one or more full phrases to the user that can be outputted as audio from the system. These recommendations may include, but are not limited to, “I am going to walk the dog”, “I just walked the dog”, “Did you walk the dog?”, “We are going for a walk”. Other phrases that have corresponding tags involving dogs, a morning time frame and dry weather may also be presented to the user.

Another factor that is considered prior to display is the historical frequency of use of the content in the established context. This ensures that content that is commonly used by the user in that context is recommended in addition to the content that may be purely recommended due to semantic relevance.

The user may select the number of content recommendations 142 they want provided to them. For instance, if a user chooses that they wish to see the top 10 recommendations, the 10 recommendations with the highest likelihood will be presented to the user. A threshold will be established to determine at which likelihood value the recommendations become irrelevant. For instance, if the system produces 15 recommendations, 8 of which are with likelihood values below 0.5, then perhaps these values should not be presented to the user. In this case, the user will only be shown 7 recommendations. Eventually, the cut-off threshold at which recommendations become significantly uninformative will be determined through usage data. Similarly, the user may select the number of experience recommendations they want provided to them. In some embodiments, a pre-defined number of recommended contents may be used to determine the threshold.

In some embodiments, a combination of one or more contexts may be defined by an “experience” which contains content that may change over time. In some embodiments, cross-referencing of combined contexts (“experiences”) may be performed to determine which content are correlated with which context tag.

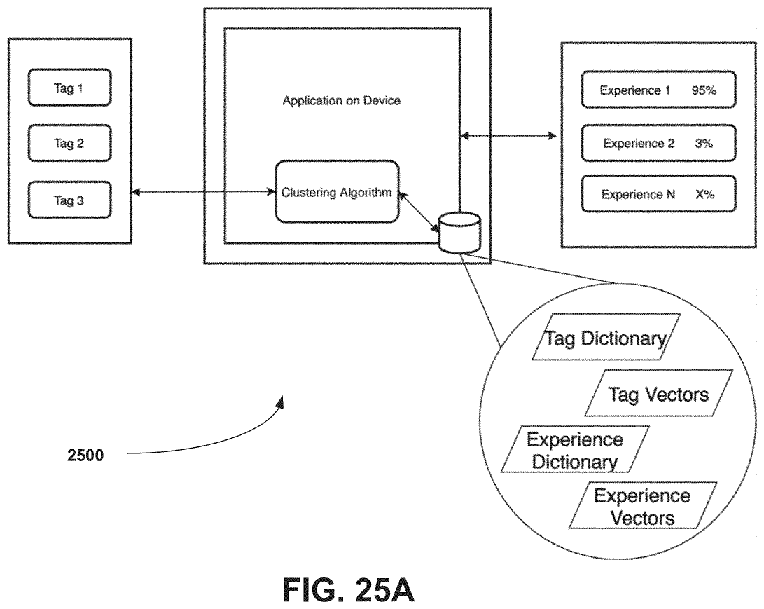

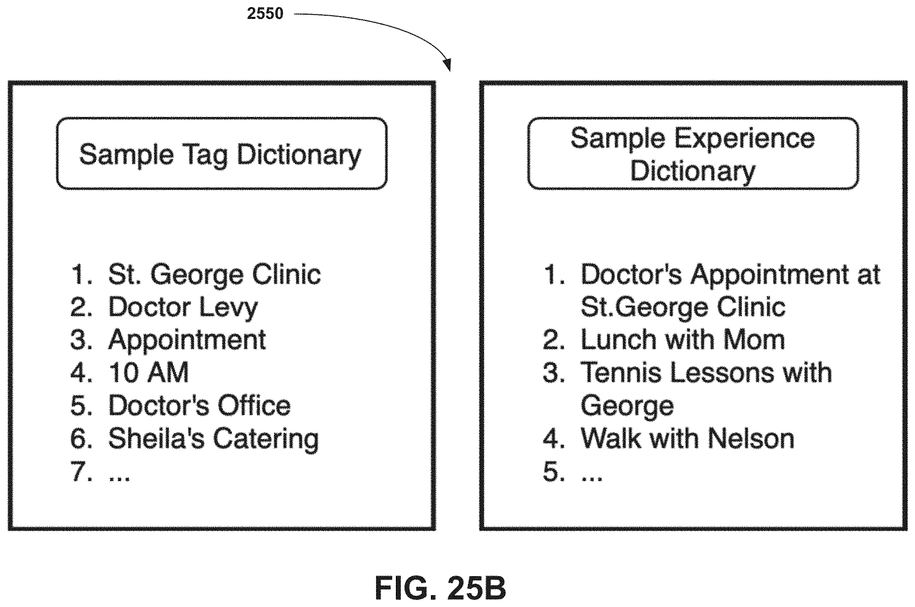

FIG. 25A illustrates an example 2500 of associating tags to experiences, in accordance with some embodiments. FIG. 25B illustrates an example of tag and experience dictionaries 2550, in accordance with some embodiments.

Once collected, the context tags will be used to identify and retrieve the most relevant experiences. This is done by a clustering algorithm (such as K-Nearest neighbours) which identifies the experiences that contain overlapping tags with the tags of the detected context. The clustering algorithm runs locally on the device. The experiences and their base tags (the tags the user has indicated as being relevant to the experience and/or the system detects as being relevant to the experience) are cached in the local database in the tag dictionary and experience dictionary. When a user adds an experience, they may manually assign tags to the experience. Additionally, tags may be automatically assigned to experiences based on common patterns in other users' selections.

Each tag is stored in the local database as a tag vector which is a floating-point representation of the tag to a low dimensional space. Experiences are also represented by experience vectors in the same sense. An embedding algorithm such as Word2Vec, which embeds both words and phrases, may be used for this purpose. References to images and icons may also be embedded using an image embedding algorithm. These dictionaries and embedding vectors are used by the clustering process to retrieve the similarities between tags and experiences. Experiences and corresponding tags, as well as their associated vectors are also backed up on the remote database on the cloud with an association to the user through an encrypted user ID. The clustering algorithm identifies the experiences with the closest similarity metric (i.e., cosine similarity) to the group of detected tag vectors and the experiences are ranked from the closest to the furthest. This ranking is quantified by percentage values as depicted above. The clustering algorithm will produce a ranked output of the experiences with the most relevance to the least relevance as a percentage out of 100%. As detected tags repeatedly and successfully map to an experience, these associations are learned through modifications to the embeddings. These modifications, in turn, result in closer similarity values between the detected tags and the experience.

An embedding algorithm transforms a tag to an embedding vector

ī=(w_{d0}, . . . ,w_{dk})

where k represents the size of the vector. Embeddings convert a tag to a low dimensional vector where the closeness of vectors indicate high relation. Any experience in the dictionary also has an associated vector such as

r̅=(w_{q0}, . . . ,w_{qk})

The cosine similarity between the tag and an experience can be described as follows:

$$Cosine Similarity ( \overline{i} , \overline{r} ) = \frac{\overline{i} \cdot \overline{r}}{\vert \overline{i} \vert \vert \overline{r} \vert} = \frac{{\sum }_{i = 1}^{k} {w}_{qk} \times {w}_{dk} }{\sqrt{{\sum }_{i = 1}^{k} {( {w}_{qk} )}^{2}} \cdot \sqrt{{\sum }_{i = 1}^{k} {( {w}_{dk} )}^{2}}}$$

It should be noted that the cosine similarity metric is used for illustrative purposes. Any similarity metric may be used.

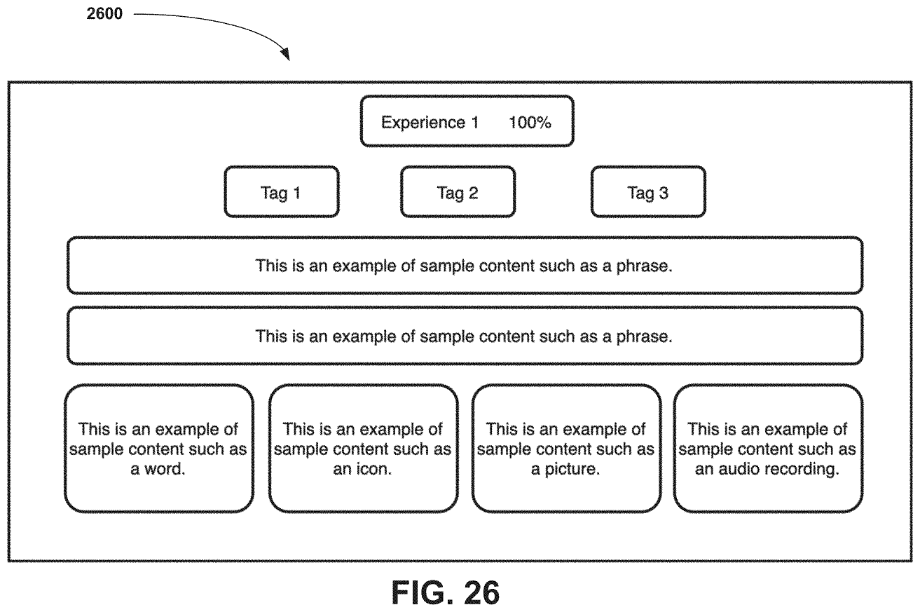

Some experiences may be related to two of three detected tags (higher relevance), for example, while other experiences may have one/none of the detected tags (lower/zero relevance). FIG. 26 illustrates an example of a content data structure 2600, in accordance with some embodiments. FIG. 26 shows an example of an experience with a 100% match, meaning it includes all and only all tags detected or selected from the content. Each experience is associated with tags which are associated with content that is user defined and/or system defined. The system defined content associated with each experience is determined through the use of the content recommender that includes the preprocessor 121 and the inference network 122 which may be embodied by a machine learning framework.

System 100 may be configured to automatically detect any changes in context based on the recorded inputs. For example, the user may move from their bedroom to the bathroom, depicting a change in context due to a change in location. In some embodiments, the system may update the experience recommendations displayed to the interface to reflect a change in context. For example, the previously recommended experience may have been “Getting ready for bed” and included content, such as words and phrases, that described making the bed, getting a blanket, watching TV, etc. The updated experience recommendation may be “Personal care”, and include content, such as words and phrases, that describe brushing teeth, taking a shower, putting on makeup, etc.

In some embodiments, the user may update their content recommendations by manually selecting an existing experience. For example, the user may often order food from McDonald's around lunch time, such that they or the system has created an experience called “McDonald's Meals”. The user may manually select the experience when the overlapping context is not detected (user location as McDonalds and time as lunch) or when context detection has failed.

In some embodiments, the system may recommend one or more full phrases to the user based on an input selection of at least one word or icon/image and the detection of related context tags. For example, a user may typically walk their dog in the morning on days when the weather is dry. The user may select the word and/or accompanying icon/image for “dog” on their system. The system may infer, through the combination of the input selection of “dog”, the detection of a time context tag that describes it is currently morning and a weather context tag that describes it is currently dry, that the user would like to communicate that they are going to walk the dog. The system may recommend one or more relevant experiences that contain phrases that the user can output as audio from the system. For example, an experience structure (e.g., folder) for a “Walking the dog” experience may be linked to or contain relevant content, such as the following words and phrases “dog”, “walk”, “I am going to walk the dog”, “Did you walk the dog?”, “We are going for a walk”, etc. For example, an experience structure (e.g., folder) for a “Walking the dog” experience may be linked to or contain relevant content, such as the following words and phrases “dog”, “walk”, “I am going to walk the dog”, “Did you walk the dog?”, “We are going for a walk”, etc.

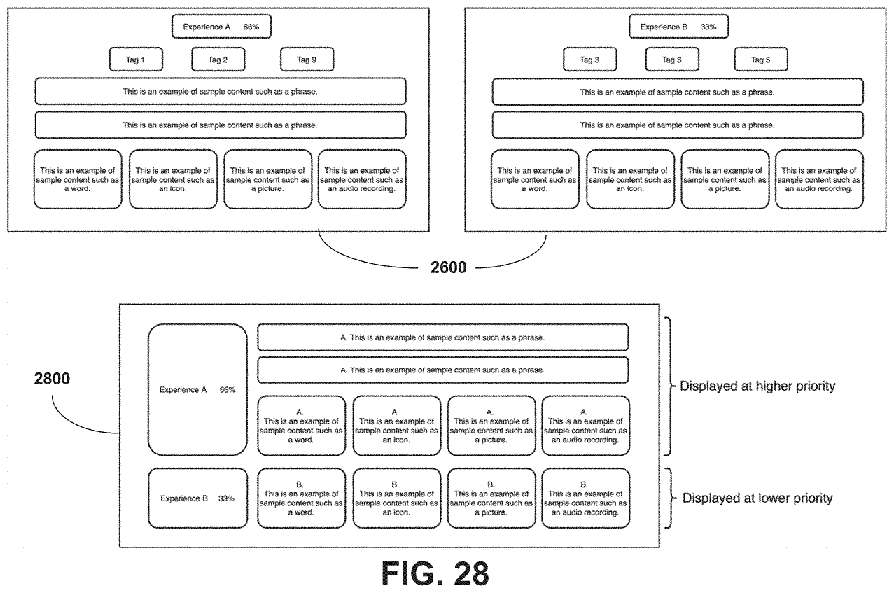

FIG. 28 illustrates examples of experience, tags and content with an imbalanced match 2800 presented to the user, in accordance with some embodiments. If there is potential for multiple experiences 2600 to match to the detected tags, the content associated with the experiences are displayed in order of priority. In the above example, content associated with experience B may also be shown on the application at a lower priority. As Experience A has a 66% match with the detected tags, all of the content associated with that experience will be displayed at a higher priority than the content associated with Experience B.

Context data collected via hardware and software methods are synthesized and weighted according to situational relevance; this is accomplished using language modeling and reinforcement learning. This approach may ultimately improve the timing and quality of communication by presenting informed word recommendations to the user on the first page of the communication software running on the device; this may be achieved through a reduction in the number of keystrokes required to formulate desired speech output. This approach will also allow for the system to learn how the user plans to grow their vocabulary. By referencing frequent situational contexts and historical content use data, the system can suggest novel, individualized content to the user. This indicates that content that has not been pre-programmed in the system can be automatically added to the database and suggested to the user. This is accomplished by learning from the user's habits and interests.

On-screen keyboards, in combination with word prediction, may be used to produce content within an experience. Additionally, the system will have an audio-visual interface that faces the user. The user may interact with the system using input/output methods such as touch for a touch screen interface, audio input/output, as well as access devices such as a switch, joystick, and eye gaze camera.

There may be a lot of content associated with a given experience. In order to provide a higher priority to some content for quick or easy access, a few factors come into play. Content that the user frequently accesses within the experience will be assigned a higher priority in terms of relevance and will be displayed at a higher visual priority and/or more accessible areas on the application.

The selected content can be spoken by a computerized voice. The selected content, if visual, can be displayed on the interface and shared with others. The selected content, if audio, can be shared through speaker output. The application will perform such translational actions.

As illustrated in FIG. 5, recommender 120 includes pre-processor 121, inference network 122, tag weight updater 123, and dictionary updater 124.

Context can be defined as the overarching circumstances under which a user is actively using system 100. There are several factors that attribute to a context; communication partner, location, time of day and user's schedule are such attributes. Context tags 119 are descriptors of each attribute. For instance, if a user is at a St. George Clinic for an appointment with their family doctor at 10 am community centre with their friend Sarah in the evening, the tags St. George Clinic, Doctor's Office, Community Centre, Family Doctor, Appointment, and “10 am” Sarah, Appointment and “10 am” and Evening will be attributed as descriptors of the context. These context tags may be automatically detected or manually set by the user. The tags stored for each user may be unique based on the contexts they frequent and personal experiences. Although users may currently have content boards (e.g., word boards) manually programmed to reflect individual tags, system 100 provides an advantage by suggesting words that would be relevant given a combination of tags.

Due to the nature of the operating system on typical phones and tablets, a lightweight network may be preferred for processing. Larger models with a large number of layers can increase the time and space complexity requiring cloud connectivity to provide recommendations. A lightweight network can allow for local processing without reliance on the cloud and constant Wi-Fi-connectivity to provide recommendations. It is preferred that most of the processing occurs locally. Thus, networks that are 2 to 4 layers are preferred.

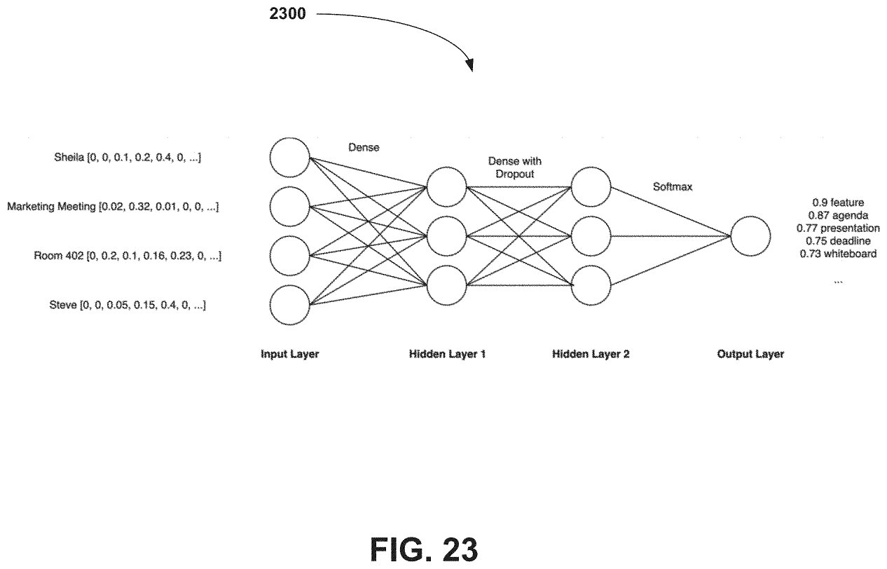

In some embodiments, the purpose of this network is to accept tag normalized similarity vectors such as the one shown in FIG. 22 and output a list of content (e.g., words, phrases, etc.) with associated probabilities. FIG. 23 provides a breakdown of the layers 2300; the input and output layers accept input and produce output while hidden layers perform internal processing. The first hidden layer is a dense layer that accepts the input vectors from pre-processing and determines the correlation between the input vectors to create a sense of a combined context. As shown in FIG. 23, a dense layer indicates that each neuron in the layer receives inputs from all the neurons in the previous layers. Here a neuron is a mathematical function that studies some relation between inputs and outputs within that layer. The second hidden layer is a dense layer with dropout after activation. Dropout prevents the network from memorizing specific combinations of relations between tags and word outputs, making it more robust at producing recommendations. This layer is designed to eliminate overlearning and obtaining outliers in the results. Even though a user says the word “salad” frequently when he is with his spouse Anita at a restaurant, this does not mean that the word “salad” has a high correlation to the tag “Anita”.

In some embodiments, the purpose of this network is to accept tag normalized vectors and output a list of content with associated probabilities. The input and output layers accept input and produce output while hidden layers perform internal processing. The first hidden layer is a dense layer that accepts the input vectors from pre-processing and determines the correlation between the input vectors to create a sense of an experience. The second layer is designed to eliminate overlearning and obtaining outliers in the results.

Without dropout, this may be assumed. The third layer is a softmax layer for producing the output. This softmax layer converts the output of hidden layer 2 to a probability distribution which, in some embodiments, is representative of the relevance of content in a given context. The output is a single vector which includes the probability that each item in the dictionary will be relevant to the user. Words such as “feature”, “agenda”, “presentation”, “deadline” and “whiteboard” which may be commonly used by the user in a work context would have a larger probability than other words in the dictionary. This process is depicted in FIG. 23. In some embodiments, the probability distribution is representative of the relevance of experiences in a given context.

Inference network 122 can generate an output 140 including recommended content 142 and associated probabilities 144, as shown, for example, in FIGS. 24A and 24B.

Recommended content 142 may be displayed in an accessible area on a screen. With more advanced algorithms providing predictions and recommendations based on a content's likelihood to be used in a specific context, significant communication rate gains may be achieved. However, research suggests that consideration must be made regarding user fatigue, usability, and task demand.

Therefore, the location of recommended content 142 on the screen and frequency at which they are dynamically updated must be considered to ensure that the cognitive load of the user is not increased. Both of these features may be customized to the user, as each user's range of ability is unique to them.

System 100 may also be configured to automatically adjust volume of voice output.

Current solutions require the user to navigate to the communication software settings in order to adjust the volume. The proposed system will access the built-in microphone of the hardware platform to approximate the ambient noise level in the user's environment and automatically adjust the voice output volume accordingly.

System 100 may also consider the distance of the user to the communication partner. The noise level and distance to the communication partner will be used to determine an appropriate volume setting; this will ensure that the user is heard by the intended audience.

System 100 may also consider the location of the user. Prior volume settings in particular user locations may be used to inform automatic adjustment of volume of voice output.

System 100 may also be configured to automatically adjust screen brightness.

Several users of existing communication software have expressed challenges with accessing the vocabulary on their systems due to the light levels in their surrounding environment. This typically arises when users transition from the indoors to a bright outdoor environment. Most hardware that runs communication software has the ability to automatically adjust screen brightness according to light levels detected in the environment. The proposed system will allow the user to select whether they would like to manually or automatically adjust the screen brightness while running the application. Additionally, system 100 can provide automatic screen brightness adjustment for individuals using the software on a hardware platform that may not have that capability. This will be achieved by leveraging the hardware platform's camera, or if available the IR camera, to detect the surrounding light level. The light level will be used to determine an appropriate brightness setting; this will ensure that the user can see the words that they'd like to access on their device.

System 100 may also be configured to automatically adjust tone of voice output.

System 100 may offer the option for users to adjust the tone of the voice output based on their emotional intent. This may be accomplished using an NLP technique called emotion analysis. By performing emotion analysis on the user's constructed messages, the associated emotion may be identified (such as happiness, anger, sadness, etc.), and a synthesized voice output that conveys the emotion may be applied.

In some embodiments, tag weights 139 and inference network 122 may be updated over time.

Tag weights 139 and content usage frequencies associated with tags 119 may change periodically through usage. It may not be desirable for tag weights 139 to be adjusted on a continuous basis, as introducing feedback on a continuous basis can introduce uncertainty for the user in terms of output results.

Weight adjustments may be performed periodically such as to strategically minimize the entropy of suggestions. Content usage frequencies will be aggregated over time and backed up to the cloud when Wi-Fi bandwidth is available. A model such as inference network 122 can be trained on the cloud with updated user data and the adjusted weights. This trained model will be pushed to the device so that users can make use of the updated recommendations. The frequency of model update will be defined over time depending on a trade-off between the value new recommendations provide and the amount of change introduced to the user's screen real-estate.

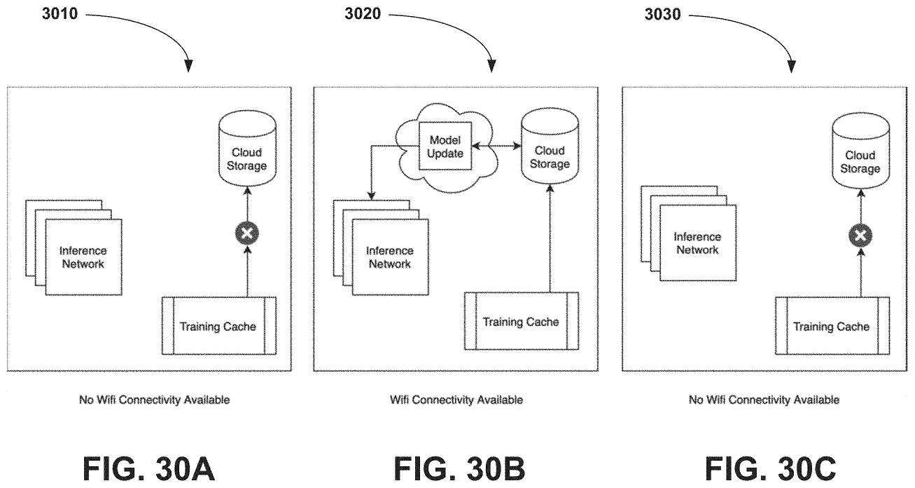

FIGS. 30A to 30C illustrate an example of Internet connectivity requirements 3010, 3020, 3030 for a model update/fine-tuning process based on historical use, in accordance with some embodiments. FIG. 30A illustrates a model update with no Wi-Fi connectivity available 3010. FIG. 30B illustrates a model update with Wi-Fi connectivity available 3020. FIG. 30C illustrates a model update with no Wi-Fi connectivity available 3030. Fine-tuning is the intermittent process of improving the model over time in accordance with user-specific data. Improvement of the model may be measured by the allowance of recommended content presented to the user for efficient and effective communication when the user is in the detected context. Any process involving fine-tuning the model requires internet connectivity. The training will occur on a remote server that may be hosted on the cloud. As hardware capabilities expand, the training may also occur on the device.

FIGS. 30A to 30C present system diagrams which demonstrate the model update process and the internet connectivity required 3010, 3020, 3030 at each stage of the process. The training cache refers to the user specific training data accumulated through the application usage. The model refers to the inference network and the associated data structures (tag weights, tag dictionary, content weights, content dictionary) required for inference. The inference process is an offline process. The model update may be triggered in accordance with a policy. This may be a state when the application is connected to the internet, a state when a fixed amount of training data has been accumulated or over a scheduled time interval. The training process may also be manually triggered as with the “Tell Us About Yourself” process. During the “Tell Us About Yourself” process, training is triggered as soon as the process is complete. The model update occurs on the cloud and transmits the updated data structures to the local storage from the cloud storage.

Tag weight updater 123 update tag and content probabilities or weights, tag weights 139 stored, for example, in tag weight data store 132. Tag weight updater 123 may be executed in an update cycle.

Tag weighting can be determined through backpropagation. Backpropagation is the process of adjusting tag weighting in order to minimize the error in predictions when inference results are compared to validation data. The usage of specific content in given contexts contribute to a higher weighting that should be reflected in the system output. Tag weights 139, which indicate how much a context tag 119 should contribute to output 140, can also be adjusted using back propagation. For example, if the user uses the word whiteboard the most frequently, subsequent recommendations will produce a higher probability 144 for the word whiteboard (0.73 to 0.8). In this case, “whiteboard” has the highest relation to Room 402 since this room has a whiteboard. If several contents closely related to Room 402 are used frequently, the weighting of this tag will increase through backpropagation thus enabling content related to Room 402 to have higher likelihoods. This process would similarly impact frequently accessed experiences within the detected context.

Dictionary updater 124 can add new content to a dictionary, stored, in an example, in dictionary data store 134. Dictionary updater 124 may be executed in an update cycle.

Some experiences may also be associated with content that varies dynamically in accordance with 3rd party APIs. For instance, a “Local News” experience may pull content using a 3rd party news API which can then be prioritized and displayed on the application for use. Automatic expansion of the content may be performed in such a manner.

The proposed system will provide prompts to add new content to the system. Users may choose to add content in bulk. The system intends to accomplish this using one, or a combination, of the following three techniques: programming new content via text, programming new content via voice input with speech recognition (either the user or a member of their care circle can execute this process) and programming new content by uploading images and converting them to other content type (e.g., words/phrases) with object and/or optical character recognition.

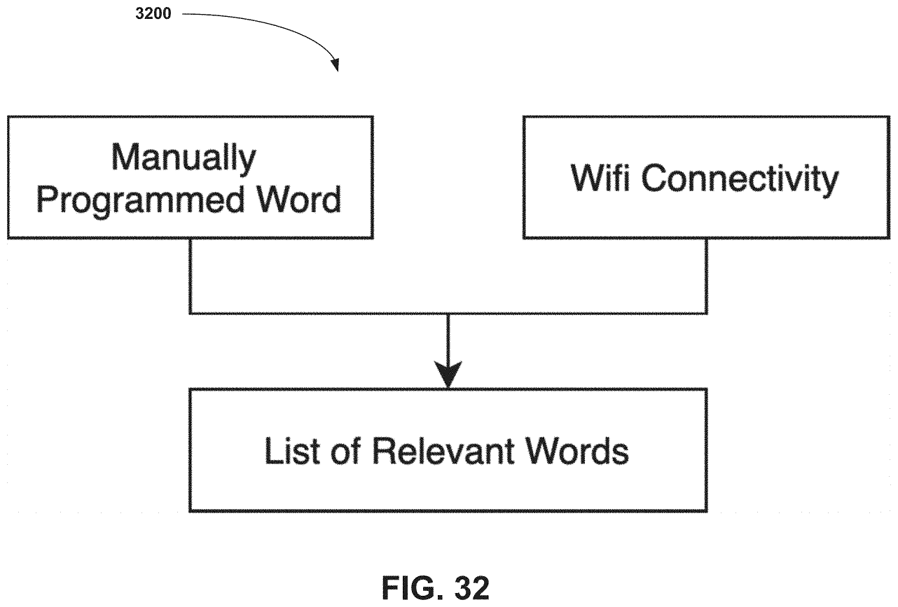

FIG. 32 illustrates an example of a process 3200 for content addition from manually programmed content, according to an embodiment. Prompts will suggest the addition of content that are relevant to a manually programmed experience. Wi-Fi connectivity will be leveraged to identify relevant content. For example, if the user manually programs the experience “Playing Catan”, words and phrases that are specific to the game, such as “wheat” and “longest road”, may be scraped from a relevant online corpus and suggested for addition to the software.

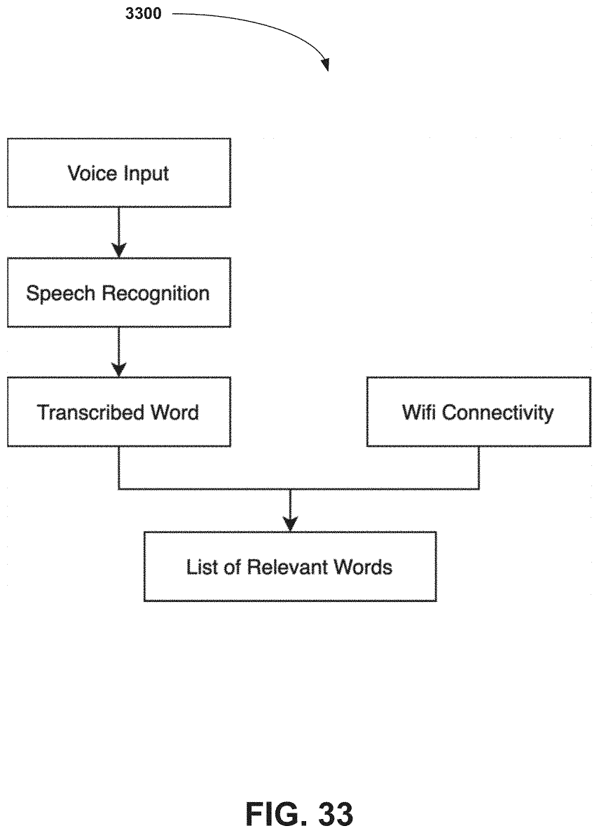

FIG. 33 illustrates an example of a process 3300 for content addition from voice input and speech recognition, according to an embodiment. Speech recognition may be employed with a communication partner. The communication partner may dictate content that will be received and transcribed via microphone input. This feature may be used to add personal terms such as nicknames or slang. Wi-Fi connectivity will be leveraged to search online corpora to identify additional content recommendations that relate to the selected experience.

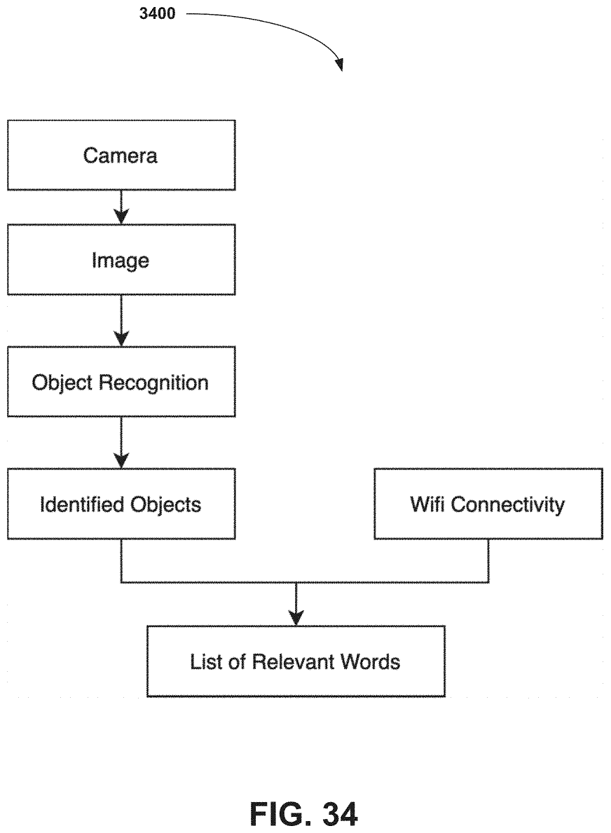

FIG. 34 illustrates an example of a process 3400 for content addition from object recognition, according to an embodiment. Users may take pictures of items that they'd like to be added to their content. These images will be passed to an object recognition model that performs processing on their local machine to establish the nature of the objects in the images. For instance, a user may take a picture of a room and all the detected items in the room will be discerned using object recognition. Additional content recommendations may be established via Wi-Fi connectivity similar to the means presented for speech recognition. Users may also take pictures of existing, physical content boards that they would like digitized versions of in the system. These images may be passed to an object recognition and optical character recognition model that performs processing on their local machine to establish the nature of the objects and text in the images. For instance, a user may take a picture of a content board for a specific topic, such as greetings, that contains words with accompanying images. The words and images on the content board will be discerned using object recognition and added as words and/or images to the system.

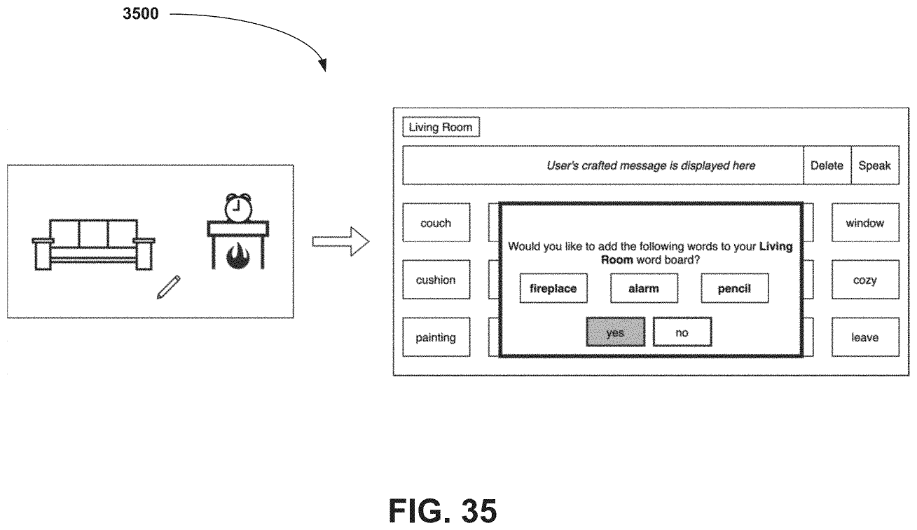

FIG. 35 illustrates an example of semi-automatic content addition through object recognition 3500, according to an embodiment. Upon review and confirmation from the user, approved content may be added to a common experience based on the common theme.

When the user adds content to their device that does not exist in the local content dictionary, the following process may be employed. Due to local storage limitations, one of the least used content in the local dictionary may be removed such that the new content can be added. The updated dictionary can then be used as outlined above by the pre-processor and inference network. For example, if the user has never used the word “scintillating” in the local dictionary, it may be removed and replaced with a newly added word, such as “project”.

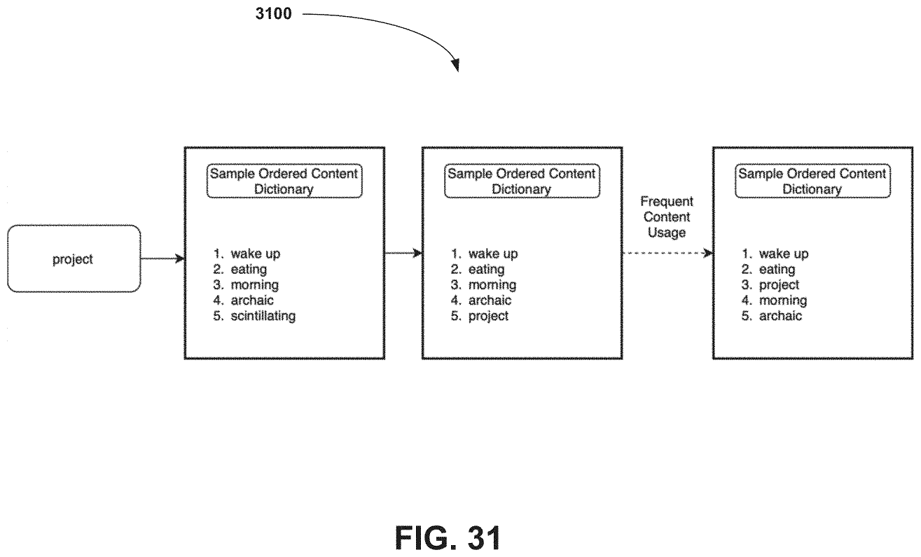

FIG. 31 illustrates an example of a process of adding content to a dictionary 3100, in accordance with some embodiments. In the example shown, the dictionary has a capacity of 5. However, dictionaries of different capacities may also be used. The content dictionary is ordered in terms of content usage. The least frequently used content is at the end of the dictionary. The new content is added to the end of the dictionary in place of the last item. With frequent usage of said content, it moves up in the ordered content dictionary.

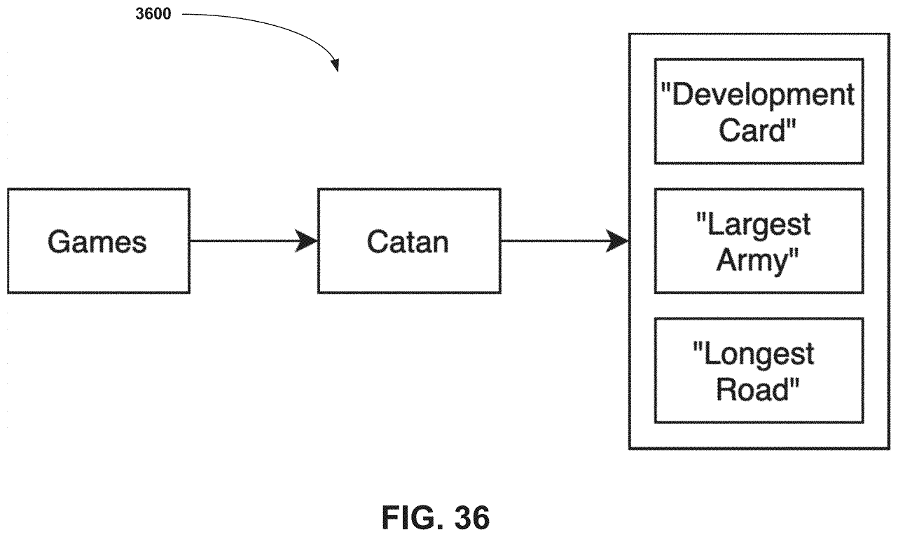

Expansion to the content dictionary may occur with content that is automatically added to the system's database being automatically placed in relevant experiences that are easily navigable by the user. For example, if the user starts playing the game Catan, and manually types that word into their device for speech output, the system may automatically create an experience containing terminology that is specific to the game, such as, “Development Card”, “Largest Army”, and “Longest Road” [26]. This content will be accessible to the user through recommendations when the device recognizes that the user is playing the game. However, in the chance that recognition fails, or the user would like to reference the content when not in the context, the user may navigate to the “Playing Catan” experience, which contains the automatically created Catan content. This sequence 3600 is demonstrated in the example shown in FIG. 36. The user will be notified upon this automatic organization to ensure they are aware of the experience structure for content storage and retrieval.

System 100 may, in some embodiments, implement cloud storage.

System 100 may provide users with the option to backup content via the cloud in order to ensure that the user's data is kept intact. In addition, users' historical usage data will also be backed up to the cloud. This includes tag weights, continuous training data and content frequency maps.

Conveniently, system 100 may ensure that users have full autonomy over which content is backed up on the cloud. It is notable that the choice to refuse backup is at the risk of potentially losing data. System 100 can take several measures to protect user's data privacy through two-factor authentication for viewing their contents that have been stored in the cloud. In some embodiments, the system 100 may allow remote access and remote backup functionality to users, speech language pathologists and caregivers can modify and monitor the configuration of the system 100.

Furthermore, device performance and maintenance data, as well as personally identifiable information (PII), may be collected by system 100. PII may be de-identified in order to not be considered sensitive data. In some embodiments, communication through system 100 such as transcription of speech data through microphone input is not stored either locally or on the cloud. Once real-time data is processed, only the meta-data may be stored in any capacity; none of the raw inputs are retained. This also applies to the speech and facial recognition procedures—no audio and/or image data is retained and any identifiers are only stored in a homomorphic encrypted state. This homomorphic encrypted state allows for processing and yields the same results as expected when using unencrypted inputs. These measures may protect privacy while ensuring user access controls are employed and data integrity is maintained.

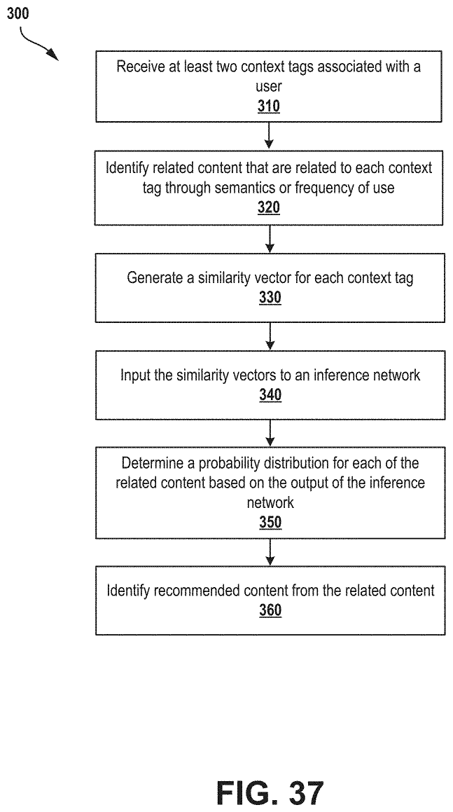

FIG. 37 illustrates a method 300 for generating recommended content, in accordance with some embodiments. Blocks 310 to 360 may be performed by recommender 120. The steps are provided for illustrative purposes. Variations of the steps, omission or substitution of various steps, or additional steps may be considered.

At block 310, context tags (e.g., at least one or at least two) associated with a user are received.

At block 320, related content is identified, from a content dictionary, content is either semantically related to each context tag or related through frequency of use while the context tag is detected.

At block 330, a similarity vector (e.g., a cosine similarity vector) is generated for each context tag that correlates the context tag with the related words for that context tag.

At block 340, the similarity vectors are input to an inference network.

At block 350, a probability distribution is determined for each of the related content, based on the output of the inference network.

At block 360, recommended content is identified from the related content, based at least in part on a threshold and the probability distributions of the related content.

It should be understood that one or more of the blocks may be performed in a different sequence or in an interleaved or iterative manner.

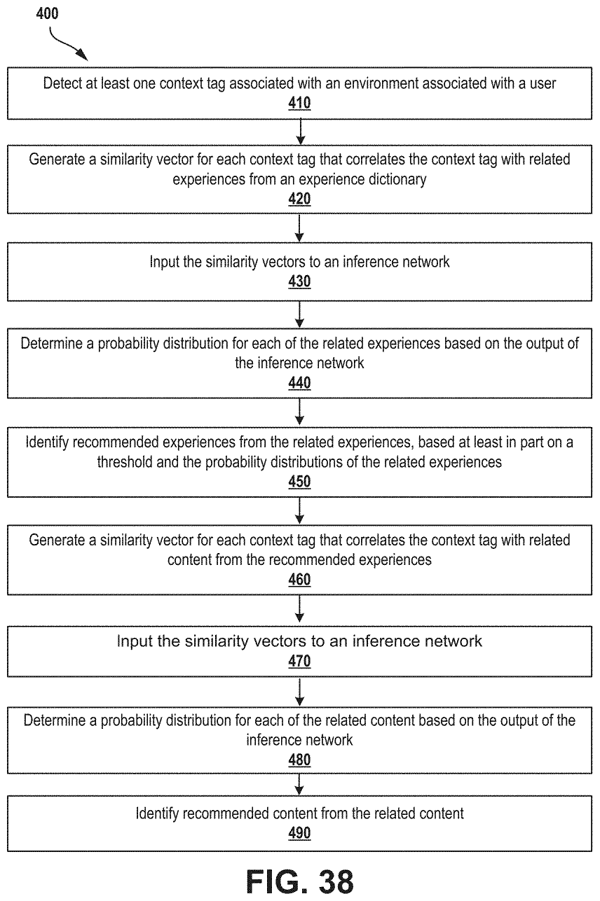

FIG. 38 illustrates a method 400 for generating recommended content based on experience, in accordance with some embodiments. Blocks 410 to 490 may be performed by recommender 120. The steps are provided for illustrative purposes. Variations of the steps, omission or substitution of various steps, or additional steps may be considered.

At block 410, at least one context tag associated with an environment associated with a user is detected.

At block 420, a similarity vector is generated for each context tag that correlates the context tag with related experiences from an experience dictionary.

At block 430, the similarity vectors are input to an inference network.

At block 440, a probability distribution is determined for each of the related experiences, based on the output of the inference network.

At block 450, recommended experiences from the related experiences are identified, based at least in part on a threshold and the probability distributions of the related experiences.

At block 460, a similarity vector is generated for each context tag that correlates the context tag with related content from the recommended experiences;

At block 470, the similarity vectors are input to an inference network;

At block 480, a probability distribution is determined for each of the related content, based on the output of the inference network.

At block 490, recommended content is identified from the related content, based at least in part on a threshold and the probability distributions of the related content.

It should be understood that one or more of the blocks may be performed in a different sequence or in an interleaved or iterative manner.

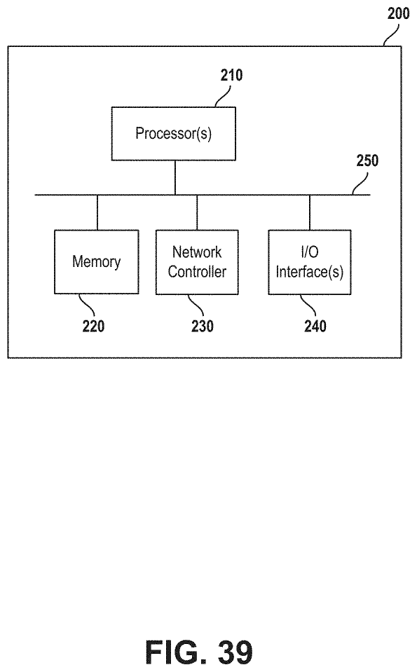

Systems and methods described herein may be implemented as software and/or hardware, for example, performed by one or more of a local computing device and/or a remote computing device such as computing device. FIG. 39 illustrates an example of a computing device 200.

Computing device 200 may be a mobile computing device Example mobile devices include without limitation, cellular phones, cellular smartphones, wireless organizers, pagers, personal digital assistants, computers, laptops, handheld wireless communication devices, wirelessly enabled notebook computers, portable gaming devices, tablet computers, or any other portable electronic device with processing and communication capabilities. In at least some embodiments, mobile devices can also include without limitation, peripheral devices such as displays, printers, touchscreens, projectors, digital watches, cameras, digital scanners and other types of auxiliary devices that may communicate with another computing device.

As illustrated, computing device 200 includes one or more processor(s) 210, memory 220, a network controller 230, and one or more I/O interfaces 240 in communication over bus 250.

Processor(s) 210 may be one or more Intel x86, Intel x64, AMD x86-64, PowerPC, ARM processors or the like.

Memory 220 may include random-access memory, read-only memory, or persistent storage such as a hard disk, a solid-state drive or the like. Read-only memory or persistent storage is a computer-readable medium. A computer-readable medium may be organized using a file system, controlled and administered by an operating system governing overall operation of the computing device.

Network controller 230 serves as a communication device to interconnect the computing device with one or more computer networks such as, for example, a local area network (LAN) or the Internet.

One or more I/O interfaces 240 may serve to interconnect the computing device with peripheral devices, such as, for example, keyboards, mice, video displays, and the like. Such peripheral devices may include a display of device 102. Optionally, network controller 230 may be accessed via the one or more I/O interfaces.

Software instructions are executed by processor(s) 210 from a computer-readable medium. For example, software may be loaded into random-access memory from persistent storage of memory 220 or from one or more devices via I/O interfaces 240 for execution by one or more processors 210. As another example, software may be loaded and executed by one or more processors 210 directly from read-only memory.

Conveniently, systems and methods provided herein may provide value to the user by increasing the rate of communication and automatically providing access to dynamic and contextual based content. This may not only alleviate pains for the primary user, but also reduce the amount of manual programming required by the caregiver. Due to the nature of features disclosed herein, users will have access to content that will grow with them and the world around them. For instance, personalized content recommendations built on beacon-based social interactions may allow for more intimate conversations among friends and family members. To address the fear of public speaking amongst system users, systems and methods disclosed herein can implement distance-based volume adjustments that further enhances the comfort experienced by all parties during a conversation.

Of course, the above-described embodiments are intended to be illustrative only and in no way limiting. The described embodiments are susceptible to many modifications of form, arrangement of parts, details and order of operation. The disclosure is intended to encompass all such modifications within its scope, as defined by the claims.

What is claimed is:

1. A computer-implemented method for generating recommended content, the method comprising:
receiving at least two context tags associated with a user;
identifying, from a content repository, related content that are related to each context tag through semantics or frequency of use;
generating a similarity vector for each context tag that correlates the context tag with the related content for that context tag;
inputting the similarity vectors to an inference network;
determining a probability distribution for each of the related content based on the output of the inference network; and
identifying the recommended content from the related content, based at least in part on a threshold and the probability distributions of the related content.

2. The computer-implemented method of claim 1, wherein the context tags define an experience associated with the user, and wherein each of the at least two context tags comprise attributes of context of the related content acquired in past communications involving the user.

3. The computer-implemented method of claim 3, wherein at least one of:
said content comprises at least one of: words, phrases, icons or images;
said content comprises words or phrases in a first language together with words or phrases in a second language; or
said content repository comprises at least one of: a word dictionary, or a phrase dictionary.

4. The computer-implemented method of claim 1, wherein each context tag is associated with a weight based at least in part on a frequency of usage.

5. The computer-implemented method of claim 4, wherein the weight associated with each context tag is updated periodically based on aggregated content usage frequencies over time.

6. The computer-implemented method of claim 1, wherein the context tags are based at least in part on one or more of: a location of the user, an identity of a communication partner, a status of an environment, a time, a mood of the user, or a mood of the communication partner.

7. The computer-implemented method of claim 6, wherein at least one of:
the location of the user is determined based at least in part on location data;
the identity of the communication partner is based at least in part on one or more of speaker recognition or a connection with a device associated with the communication partner;
the status of the environment is based at least in part on weather data;
the time is based at least in part on at least one of: a calendar event, a current event, or a duration of a calendar event or a current event;
the mood of the user is based at least in part on one or more of emotion analysis of text or emotion analysis of speech; or
the mood of the communication partner is based at least in part on one or more of emotion analysis of text or emotion analysis of speech.

8. The computer-implemented method of claim 1, comprising:
receiving an input selection of at least one word or icon; and
providing a full phrase recommendation based on the input selection and related context tags.

9. The computer-implemented method of claim 1, comprising:
receiving additional context tags associated with other users based on shared experiences;
identifying, from the content repository, related content that are semantically related to each additional context tag; and
populating a base model of shared experiences between the user and other users.

10. The computer-implemented method of claim 1, comprising pre-populating content using images of at least one of content or content boards.

11. The computer-implemented method of claim 9, wherein populating the base model comprises at least one of:
obtaining crowd source data from experiences shared among a group of users;
obtaining data from shared experiences among a group of users;
obtaining experience data associated with the user, and training the base model using said experience data associated with the user;
obtaining anonymized experience data from at least two users, identifying similarities among anonymized experience data, and selecting a pre-defined base model that matches the similarities among the anonymized experience data; and
determining a category associated with the user, and selecting a pre-defined base model for that category.

12. The computer-implemented method of claim 1, wherein the similarity vector is generated using a content embedding model.

13. The computer-implemented method of claim 1, comprising presenting/displaying the recommended content.

14. The computer-implemented method of claim 1, comprising:
receiving new content; and
adding the new content to the content repository.

15. The computer-implemented method of claim 14, wherein the new content is determined based on at least one of:
text entry;
speaker recognition;
optical character recognition; or
object recognition.

16. The computer-implemented method of claim 1, further comprising determining an audio associated with the recommended content, based at least in part on the context tags.

17. The computer-implemented method of claim 1, wherein the recommended content is based at least in part on historical content use frequency.

18. The computer-implemented method of claim 1, wherein the threshold is based at least in part on a pre-defined number of recommended contents.

19. A computer system comprising:
a processor;
a memory in communication with the processor, the memory storing instructions that when executed by the processor cause the processor to perform the method of claim 1.

20. A non-transitory computer readable medium comprising a computer readable memory storing computer executable instructions thereon that when executed by a computer causes the computer to perform the method of claim 1.
